(19) United States
(12) Patent Application Publication
(10) Pub. No.: US 2025/0344023 A1
(43) Pub. Date: Nov. 6, 2025

(54) SUSPENSION MEMBERS FOR AUDIO PLAYBACK DEVICES

(71) Applicant: Sonos, Inc., Goleta, CA (US)

(72) Inventors: Michael Ahrens, San Luis Obispo, CA (US); Stephen Everett, Natick, MA (US); Timothy W. Sheen, Brighton, MA (US); Jonathan Oswaks, Thousand Oaks, CA (US); Nigel Pemberton-Pigott, Goleta, CA (US)

(21) Appl. No.: 18/862,444

(22) PCT Filed: May 5, 2023
(86) PCT No.: PCT/US2023/066646

§ 371 Date: Nov. 1, 2024

Related U.S. Application Data
(60) Provisional application No. 63/364,324, filed on May 6, 2022.

(51) Int. Cl. H04R 9/04; H04R 7/18; H04R 9/06; H04R 9/08

(52) U.S. Cl. CPC H04R 9/043; H04R 7/18; H04R 9/06; H04R 9/08; H04R 2400/11

(57) ABSTRACT

A negative-stiffness audio transducer assembly includes a frame, a voice coil configured to move a diaphragm inward or outward along an axis, and a suspension assembly coupled to the frame and the voice coil. The suspension assembly includes a first spring having a radially outer end portion coupled to the frame, a radially inner end portion coupled to the voice coil, and an intermediate portion therebetween that is displaced in an axial direction from the first end portion and the second end portion. A second spring is arranged opposite the first spring with respect to the voice coil, and includes a radially outer end portion coupled to the frame, a radially inner end portion coupled to the voice coil, and an intermediate portion therebetween that is displaced in an axial direction from the first end portion and the second end portion.

### CROSS-REFERENCE TO RELATED APPLICATION(S)

The present application claims priority to U.S. Provisional Application No. 63,364,324, filed May 6, 2022, which is hereby incorporated by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, examples, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with examples of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partially schematic diagram of a control device.

FIG. 2A is a front isometric view of a playback device configured in accordance with examples of the disclosed technology.

FIG. 2B is a front isometric view of the playback device of FIG. 2A without a grille.

FIG. 2C is an exploded view of the playback device of FIG. 2A.

FIG. 3A is a block diagram of a playback device in accordance with examples of the disclosed technology.

FIG. 3B is a perspective view of a playback device in accordance with examples of the disclosed technology.

FIG. 3C is a side cross-sectional view of the playback device of FIG. 3B.

FIG. 3D is a top perspective cross-sectional view of the playback device of FIG. 3B.

FIG. 3E is a top perspective cross-sectional view of the transducer of the playback device of FIG. 3B.

FIG. 3F is a perspective view of the suspension assembly of the transducer shown in FIGS. 3C-3E.

FIG. 3G is a perspective view of a suspension member in accordance with examples of the present technology.

FIG. 3H is a top plan view of the suspension member shown in FIG. 3G.

FIG. 4A is a perspective view of a negative-stiffness transducer in accordance with examples of the present technology.

FIG. 4B is a perspective view of the transducer shown in FIG. 4A with some components shown transparently for clarity.

FIG. 5A is a perspective view of a suspension assembly of a negative-stiffness transducer in accordance with examples of the present technology.

FIG. 5B is a perspective view a suspension sub-assembly of a negative-stiffness transducer in accordance with examples of the present technology.

FIG. 6A is a schematic top view of a pre-loading process for a suspension assembly in accordance with examples of the present technology.

FIG. 6B is a perspective view of the pre-loading process for the suspension assembly shown in FIG. 6A.

FIG. 6C is a side view of a pre-loading fixture shown in FIGS. 6A and 6B.

FIG. 7A is a side view of a portion of a suspension assembly during a pre-loading process in accordance with examples of the present technology.

FIG. 7B is a top perspective view of a portion of the suspension assembly shown in FIG. 7A.

FIG. 7C is a side view of a portion of the suspension assembly shown in FIGS. 7A and 7B in an unsecured configuration.

FIG. 7D is a side view of a portion of the suspension assembly shown in FIGS. 7A-7C in a secured configuration.

FIG. 8A is a side view of a portion of a suspension assembly during a pre-loading process in accordance with examples of the present technology.

FIG. 8B is a top perspective view of a portion of the suspension assembly shown in FIG. 8A.

The drawings are for the purpose of illustrating example examples, but those of ordinary skill in the art will understand that the technology disclosed herein is not limited to the arrangements and/or instrumentality shown in the drawings.

### DETAILED DESCRIPTION

### I. Overview

Conventional audio transducers often include several suspension members, such as a spider and a surround, which can keep other components within the audio transducer properly positioned. These suspension members have a stiffness, which represents the extent to which each suspension member resists displacement in response to an applied force. Typically, the stiffness value for each suspension part is a positive value, meaning each suspension member resists movement against the direction of the applied force. This property of suspension members is desirable for keeping other components within the audio transducers properly aligned and facilitates the oscillating pistonic motion of the diaphragm during operation.

While the positive stiffness of the suspension members is beneficial for keeping other components within the audio transducers aligned, this stiffness can have some drawbacks in an audio transducer. For example, the suspension members can decrease the efficiency of the audio transducer, as the audio transducer needs to consume additional power to overcome the transducer's stiffness from the suspension members to operate.

Examples of the present technology can address these and other issues by utilizing one or more suspension members with a negative stiffness value. Unlike suspension members with a positive stiffness value, suspension members with a negative stiffness value do not resist displacement, but rather respond with an additional force in the same direction as the applied force. As a result of this property, components within the audio transducer, such as the diaphragm, can move with less resistance from the suspension members in a sealed enclosure. Thus, these negative stiffness suspension members can decrease the amount of power that is needed to operate the audio transducer, as there is less stiffness to overcome within the system for moving components, like the voice coil.

In some examples, the suspension members couple to the frame and to the voice coil of the audio transducer. Additionally, the suspension members can include one or more springs or spring-like members that are compressed when the suspension members are coupled to the frame and voice coil. In this compressed state, the voice coil can remain at rest at an axially central position in which the forces due to the suspension members are balanced. However, when the voice coil is moved axially inward (or outward) away from the rest position, the suspension members exert an inward (or outward) force that urges the voice coil further along its direction of movement. Accordingly, these suspension members contribute a negative stiffness along the axial direction.

Although compressing the suspension members can result in the suspension members having a negative stiffness value, this compression can create high levels of stress within the suspension member. In some examples, the stress resulting from the compression can lead to the suspension members failing under normal operating conditions.

Examples of the present technology can address these and other issues by configuring the suspension member such that stress is distributed across or throughout the component rather than concentrated in a specific region. In some examples, the suspension member can include one or more corrugated portions. These corrugated portions can distribute the stress from the high stress areas to other areas of the suspension member. In various examples, the suspension member can include one or more narrowed portions. These narrowed portions can also reduce the amount of stress experienced at a particular point along the suspension member. Accordingly, by carefully configuring the suspension member, the suspension member can reduce the stiffness within the audio transducer while also being capable of withstanding the stress experienced under normal operating conditions.

In some implementations, the suspension members can take the form of spring members that are arranged in radially opposing pairs around the voice coil. Each of the radially opposing pairs can include one spring member that protrudes in the axially outward direction along its intermediate portion, and another spring member that protrudes in the axially inward direction along its intermediate portion. This configuration can allow a high degree of axial travel for the spring members while also maintaining axial balance at the rest position.

According to some examples, some or all of the spring members can be made of a material having a high stiffness and relatively low mass. Example materials can include reinforced plastics (e.g., reinforced with carbon fibers, carbon nanotubes, etc.), stainless steel, other metals or metal alloys, or any other suitable material.

In negative-stiffness audio transducers, the stiffness of spring members or other suspension members can be a key variable affecting operation of the device. For example, there may be an optimum range of compression for each spring member to achieve a desired overall spring performance for negative-stiffness implementations. In addition to achieving a desired compression value for a given spring member, it can be important to ensure consistent compression across spring members. For instance, with a plurality of spring members arranged circumferentially around the voice coil and disposed in compression, any variation in the amount of compression across individual spring members can lead to instability, poor performance, and/or audible distortion. In some aspects, the present technology can address these and other problems by providing a suspension assembly in which spring members are pre-loaded in a compressed state and secured to an annular frame or other supporting structure. The spring members can include attachment features that facilitate coupling the radially outer ends of the spring members to the frame while also allowing a compressive device (e.g., a linear actuator or other suitable compressing mechanism) to mate with the spring member ends to force them into the desired position with appropriate loading. For example, a radially outer end of a spring member can include an attachment feature having a receptacle for mating with the annular frame and an interface for engaging with a compressive device. The compressive device can provide a radially inward force on the spring via the interface of the attachment feature until the attachment feature is positioned at a desired location. The radially outer end of the spring member can then be secured to the frame, for instance by using a fastener to affix the attachment feature of the spring member to the annular frame.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

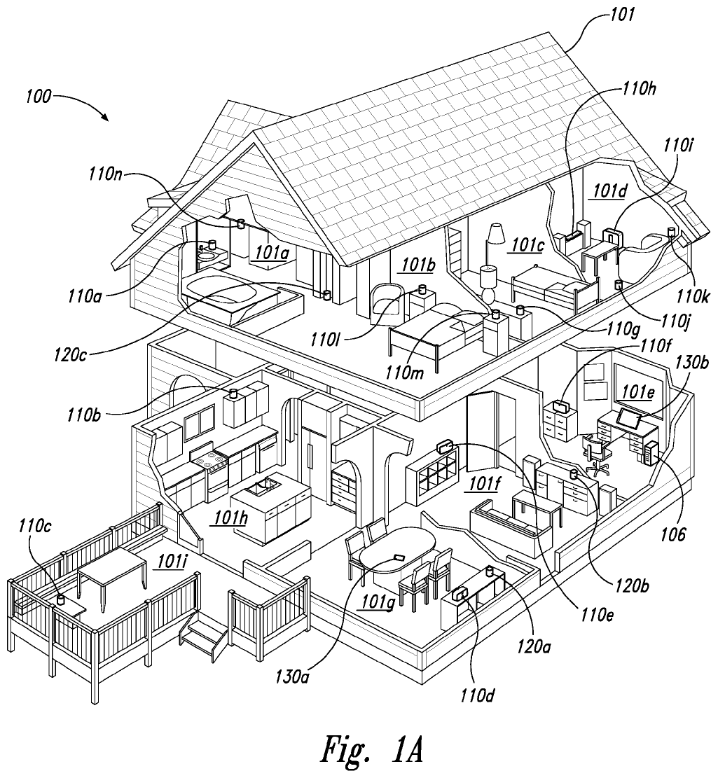

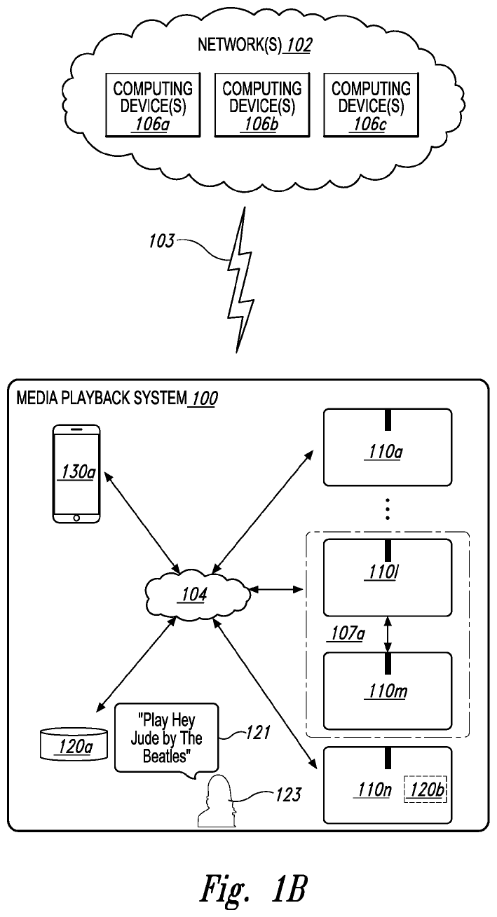

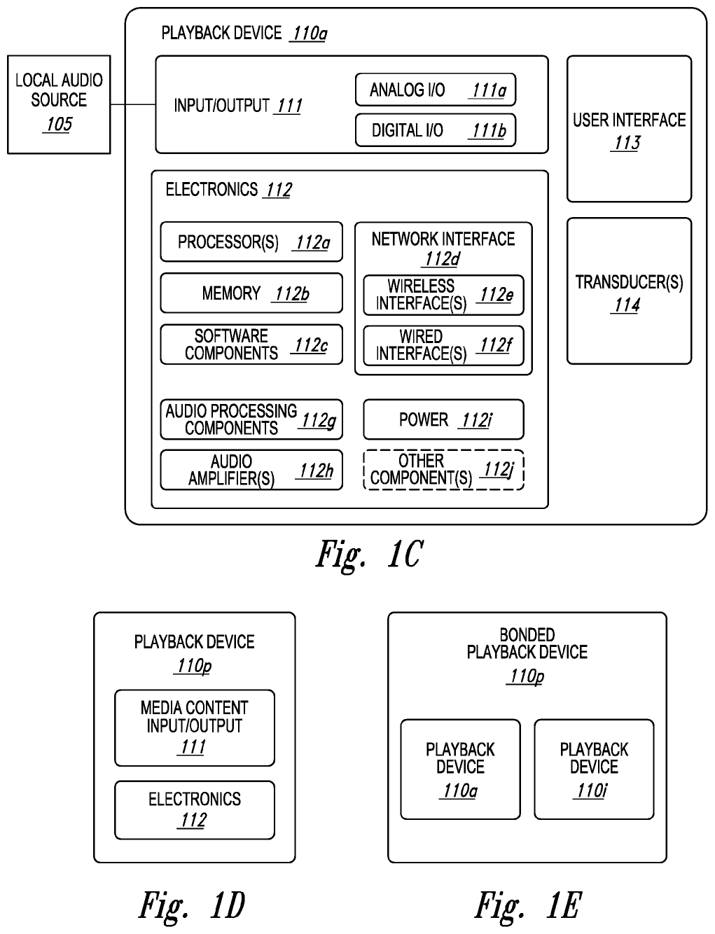

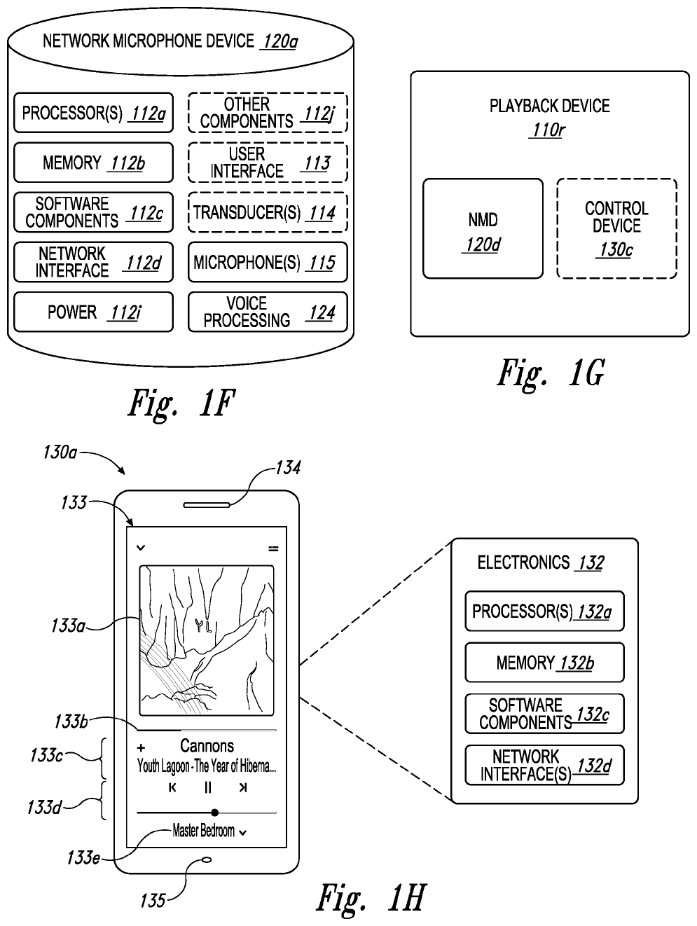

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular examples of the disclosed technology. Accordingly, other examples can have other details, dimensions, angles and features without departing from the spirit or scope of the disclosure. In addition, those of ordinary skill in the art will appreciate that further examples of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some examples, a playback device includes one or more transducers or speakers powered by one or more amplifiers. In other examples, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some examples, an NMD is a stand-alone device configured primarily for audio detection. In other examples, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain examples, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some examples, for instance, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various examples of the disclosure are described in greater detail below.

In the illustrated example of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain examples are described below in the context of a home environment, the technologies described herein may be implemented in other types of environments. In some examples, for instance, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some examples, a single playback zone may include multiple rooms or spaces. In certain examples, a single room or space may include multiple playback zones.

In the illustrated example of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some examples, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip-hop music being played back by playback device 110c on the patio 101i. In some examples, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some examples, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some examples, one or more of the computing devices 106 comprise modules of a single computer or server. In certain examples, one or more of the computing devices 106 comprise one or more modules, computers, and/or servers. Moreover, while the cloud network 102 is described above in the context of a single cloud network, in some examples the cloud network 102 comprises a plurality of cloud networks comprising communicatively coupled computing devices. Furthermore, while the cloud network 102 is shown in FIG. 1B as having three of the computing devices 106, in some examples, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11 g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some examples, the network 104 comprises a dedicated communication network that the media playback system 100 uses to transmit messages between individual devices and/or to transmit media content to and from media content sources (e.g., one or more of the computing devices 106). In certain examples, the network 104 is configured to be accessible only to devices in the media playback system 100, thereby reducing interference and competition with other household devices. In other examples, however, the network 104 comprises an existing household communication network (e.g., a household WiFi network). In some examples, the links 103 and the network 104 comprise one or more of the same networks. In some examples, for example, the links 103 and the network 104 comprise a telecommunication network (e.g., an LTE network, a 5G network). Moreover, in some examples, the media playback system 100 is implemented without the network 104, and devices comprising the media playback system 100 can communicate with each other, for example, via one or more direct connections, PANs, telecommunication networks, and/or other suitable communication links.

In some examples, audio content sources may be regularly added or removed from the media playback system 100. In some examples, for instance, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some examples, for instance, the media content database is stored on one or more of the playback devices 110, network microphone devices 120, and/or control devices 130.

In the illustrated example of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain examples, for instance, the group 107a comprises a bonded zone in which the playback devices 110l and 110m comprise left audio and right audio channels, respectively, of multi-channel audio content, thereby producing or enhancing a stereo effect of the audio content. In some examples, the group 107a includes additional playback devices 110. In other examples, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated example of FIG. 1B, the NMD 120a is a standalone device and the NMD 120d is integrated into the playback device 110n. The NMD 120a, for example, is configured to receive voice input 121 from a user 123. In some examples, the NMD 120a transmits data associated with the received voice input 121 to a voice assistant service (VAS) configured to (i) process the received voice input data and (ii) transmit a corresponding command to the media playback system 100. In some examples, for instance, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some examples, the analog I/O 111a is an audio line-in input connection comprising, for example, an auto-detecting 3.5 mm audio line-in connection. In some examples, the digital I/O 111b comprises a Sony/Philips Digital Interface Format (S/PDIF) communication interface and/or cable and/or a Toshiba Link (TOSLINK) cable. In some examples, the digital I/O 111b comprises a High-Definition Multimedia Interface (HDMI) interface and/or cable. In some examples, the digital I/O) 111b includes one or more wireless communication links comprising, for example, a radio frequency (RF), infrared, WiFi, Bluetooth, or another suitable communication protocol. In certain examples, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some examples, the local audio source 105 includes local music libraries on a smartphone, a computer, a networked-attached storage (NAS), and/or another suitable device configured to store media files. In certain examples, one or more of the playback devices 110, NMDs 120, and/or control devices 130 comprise the local audio source 105. In other examples, however, the media playback system omits the local audio source 105 altogether. In some examples, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some examples, the playback device 110a optionally includes one or more microphones 115 (e.g., a single microphone, a plurality of microphones, a microphone array) (hereinafter referred to as “the microphones 115”). In certain examples, for example, the playback device 110a having one or more of the optional microphones 115 can operate as an NMD configured to receive voice input from a user and correspondingly perform one or more operations based on the received voice input.

In the illustrated example of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some examples, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some examples, the operations further include causing the playback device 110a to send audio data to another one of the playback devices 110a and/or another device (e.g., one of the NMDs 120). Certain examples include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some examples, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some examples, for instance, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated example of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some examples, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain examples, the network interface 112d includes the wired interface 112f and excludes the wireless interface 112e. In some examples, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some examples, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain examples, one or more of the audio processing components 112g can comprise one or more subcomponents of the processors 112a. In some examples, the electronics 112 omits the audio processing components 112g. In some examples, for instance, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some examples, for instance, the amplifiers 112h include one or more switching or class-D power amplifiers. In other examples, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain examples, the amplifiers 112h comprise a suitable combination of two or more of the foregoing types of power amplifiers. Moreover, in some examples, individual ones of the amplifiers 112h correspond to individual ones of the transducers 114. In other examples, however, the electronics 112 includes a single one of the amplifiers 112h configured to output amplified audio signals to a plurality of the transducers 114. In some other examples, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz. (Hz) and 20 kilohertz. (kHz)). In some examples, the transducers 114 can comprise a single transducer. In other examples, however, the transducers 114 comprise a plurality of audio transducers. In some examples, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain examples, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “MOVE,” “PLAY:5,” “BEAM,” “PLAYBAR,” “PLAYBASE,” “PORT,” “BOOST,” “AMP,” and “SUB.” Other suitable playback devices may additionally or alternatively be used to implement the playback devices of example examples disclosed herein. Additionally, one of ordinary skilled in the art will appreciate that a playback device is not limited to the examples described herein or to SONOS product offerings. In some examples, for example, one or more playback devices 110 comprises wired or wireless headphones (e.g., over-the-ear headphones, on-ear headphones, in-ear earphones). In other examples, one or more of the playback devices 110 comprise a docking station and/or an interface configured to interact with a docking station for personal mobile media playback devices. In certain examples, a playback device may be integral to another device or component such as a television, a lighting fixture, or some other device for indoor or outdoor use. In some examples, a playback device omits a user interface and/or one or more transducers. For example, FIG. 1D is a block diagram of a playback device 110p comprising the input/output 111 and electronics 112 without the user interface 113 or transducers 114.

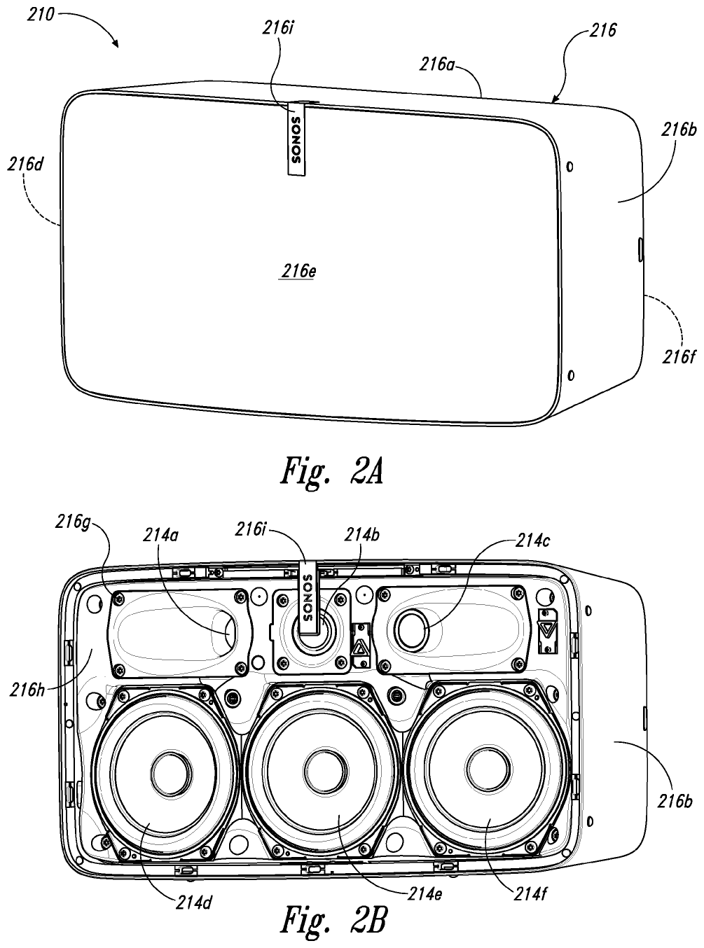

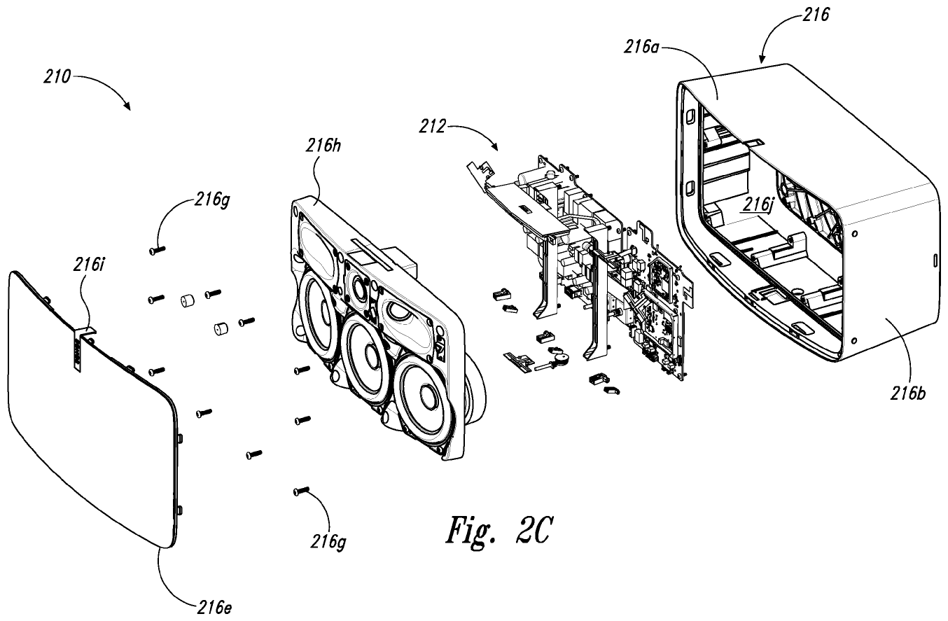

FIG. 1E is a block diagram of a bonded playback device 110q comprising the playback device 110a (FIG. 1C) sonically bonded with the playback device 110i (e.g., a subwoofer) (FIG. 1A). In the illustrated example, the playback devices 110a and 110i are separate ones of the playback devices 110 housed in separate enclosures. In some examples, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some examples, for instance, the playback device 110a is full-range playback device configured to render low frequency, mid-range frequency, and high frequency audio content, and the playback device 110i is a subwoofer configured to render low frequency audio content. In some examples, the playback device 110a, when bonded with the first playback device, is configured to render only the mid-range and high frequency components of a particular audio content, while the playback device 110i renders the low frequency component of the particular audio content. In some examples, the bonded playback device 110q includes additional playback devices and/or another bonded playback device. Additional playback device examples are described in further detail below with respect to FIGS. 2A-2C.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some examples, the NMD 120a is configured as a media playback device (e.g., one or more of the playback devices 110), and further includes, for example, one or more of the audio components 112g (FIG. 1C), the amplifiers 114, and/or other playback device components. In certain examples, the NMD 120a comprises an Internet of Things (IoT) device such as, for example, a thermostat, alarm panel, fire and/or smoke detector, etc. In some examples, the NMD 120a comprises the microphones 115, the voice processing components 124, and only a portion of the components of the electronics 112 described above with respect to FIG. 1B. In some examples, for instance, the NMD 120a includes the processor 112a and the memory 112b (FIG. 1B), while omitting one or more other components of the electronics 112. In some examples, the NMD 120a includes additional components (e.g., one or more sensors, cameras, thermometers, barometers, hygrometers).

In some examples, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other examples, however, the playback device 110r receives commands from another control device (e.g., the control device 130a of FIG. 1B).

Referring again to Figure IF, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifies a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated example, the control device 130a comprises a smartphone (e.g., an iPhone™ an Android phone) on which media playback system controller application software is installed. In some examples, the control device 130a comprises, for example, a tablet (e.g., an iPad™), a computer (e.g., a laptop computer, a desktop computer), and/or another suitable device (e.g., a television, an automobile audio head unit, an IoT device). In certain examples, the control device 130a comprises a dedicated controller for the media playback system 100. In other examples, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some examples, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130 to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit crossfade mode, etc. The playback control region 133d may also include selectable icons to modify equalization settings, playback volume, and/or other suitable playback actions. In the illustrated example, the user interface 133 comprises a display presented on a touch screen interface of a smartphone (e.g., an iPhone™, an Android phone) In some examples, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some examples, the one or more speakers comprise individual transducers configured to correspondingly output low frequencies, mid-range frequencies, and/or high frequencies. In some examples, for instance, the control device 130a is configured as a playback device (e.g., one of the playback devices 110). Similarly, in some examples the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some examples, two or more of the microphones 135 are arranged to capture location information of an audio source (e.g., voice, audible sound) and/or configured to facilitate filtering of background noise. Moreover, in certain examples, the control device 130a is configured to operate as a playback device and an NMD. In other examples, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Example Systems and Devices

FIG. 2A is a front isometric view of a playback device 210 configured in accordance with examples of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some examples, the playback device 210 includes a number of transducers different than those illustrated in FIGS. 2A-2C. For example, the playback device 210 can include fewer than six transducers (e.g., one, two, three). In other examples, however, the playback device 210 includes more than six transducers (e.g., nine, ten). Moreover, in some examples, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated example of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some examples, however, the playback device 210 omits the filter 216i. In other examples, the playback device 210 includes one or more additional filters aligned with the transducers 214b and/or at least another of the transducers 214.

### A. Example Negative-Stiffness Audio Transducers

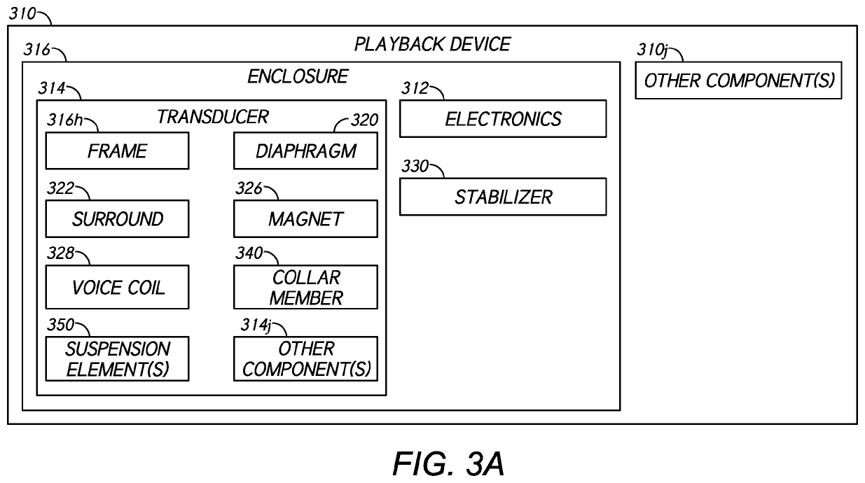

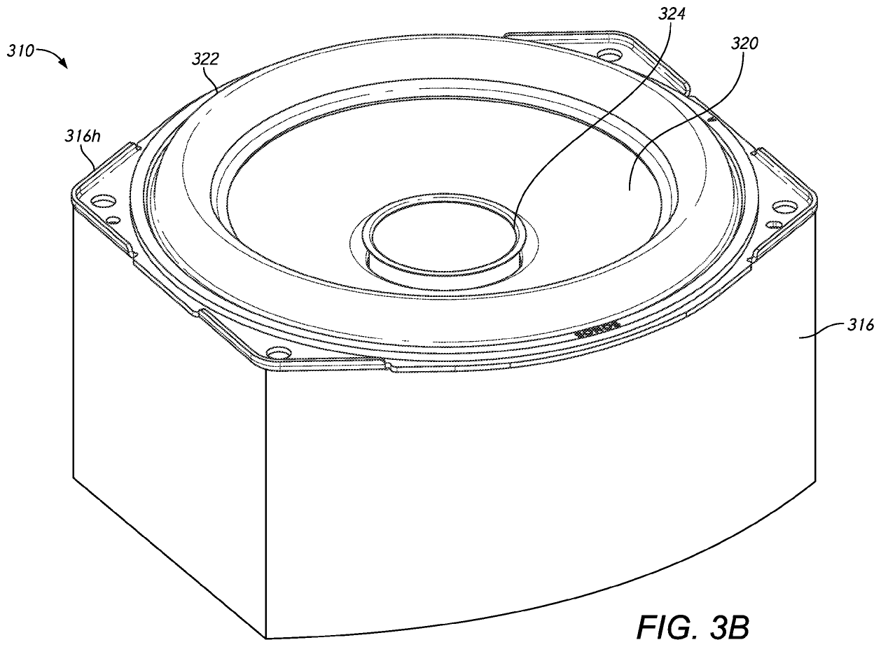

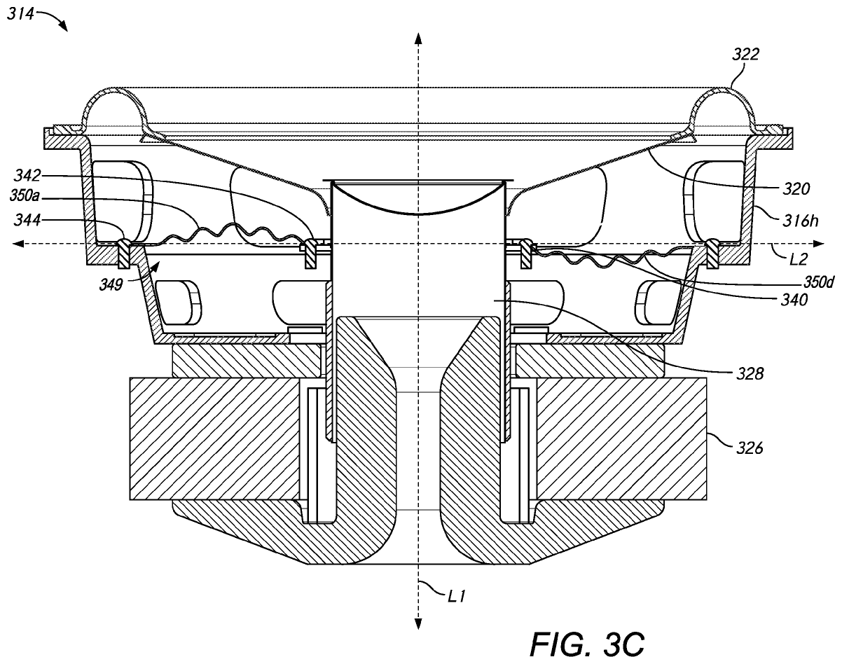

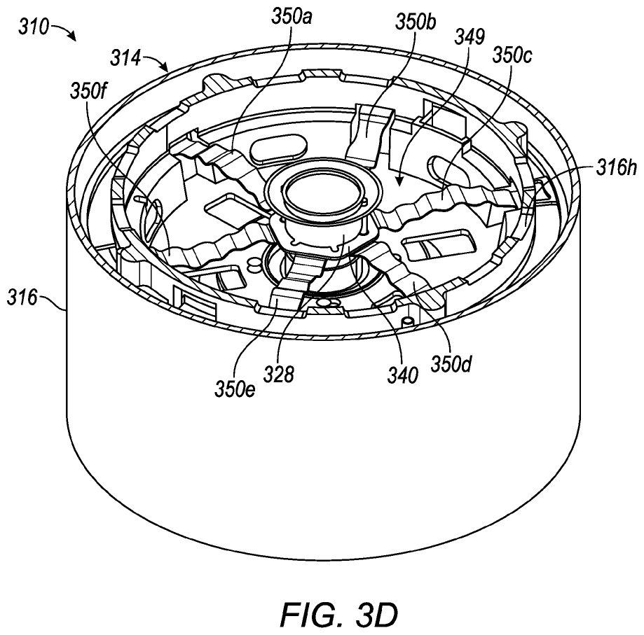

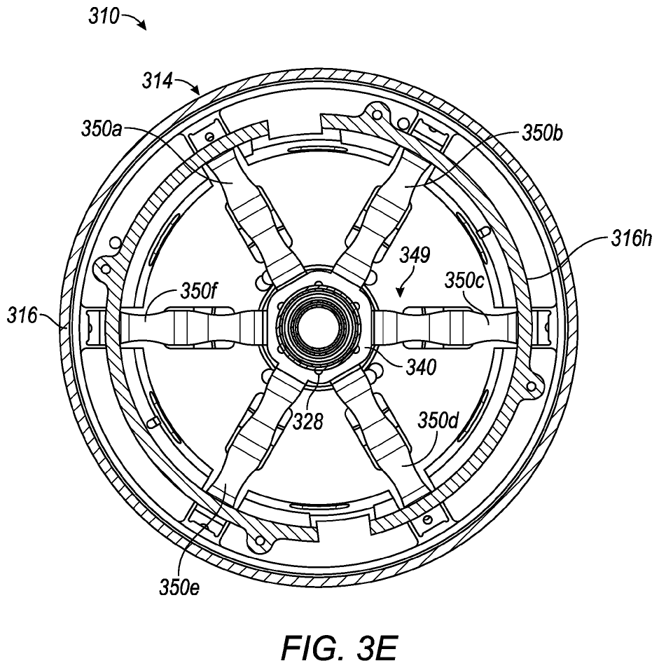

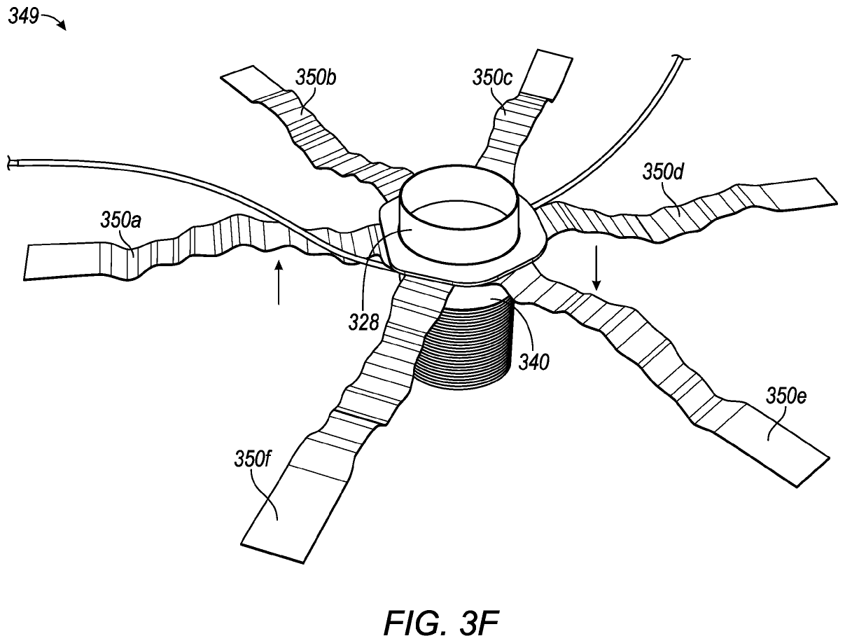

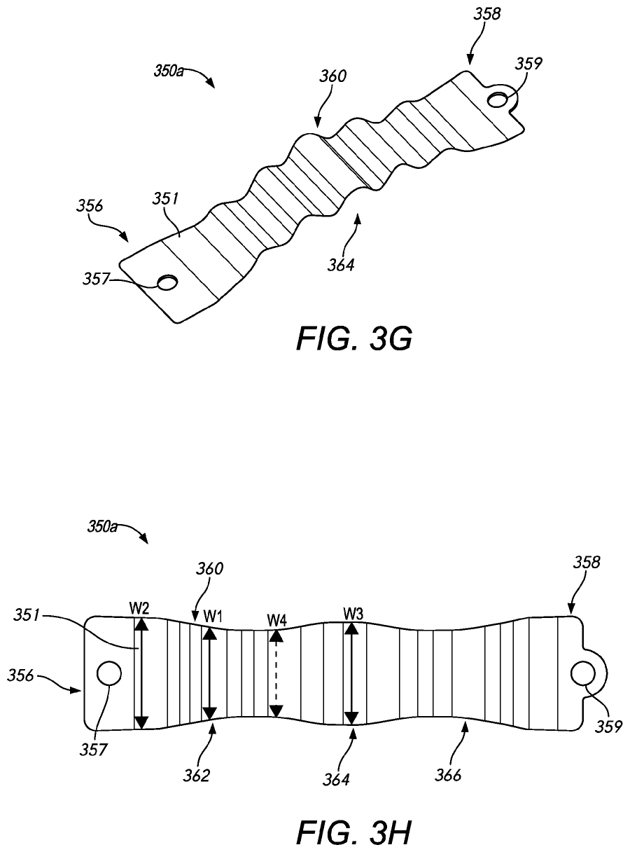

As noted previously, stiffness within an audio transducer can reduce efficiency of the audio transducer as well as decrease acoustic performance. An audio transducer having a suspension member with a negative stiffness can reduce the total stiffness of the audio transducer, and, as a result, provide distinct advantages. However, these suspension members can be subjected to high levels of stress during operation, which can cause these suspension members to fail even under normal operating conditions. Examples of the present disclosure provide negative stiffness suspension members that include one or more stress distributing features. These stress distributing features allow for the suspension member with a negative stiffness to withstand the operating stress. Examples of such suspension members are described below with respect to FIGS. 3A-3H. Through this document, the term “suspension member” can be substituted with “suspension member” or “suspension component.”

FIGS. 3A and 3B are a block diagram and a perspective view, respectively, of a playback device 310 including a transducer 314. FIG. 3C is a schematic cross-sectional view of the transducer 314. FIGS. 3D and 3E are perspective and top views, respectively, of the transducer 314 with several components hidden for clarity including the diaphragm. FIG. 3F is a perspective view of the suspension assembly removed from the transducer 314. FIGS. 3G and 3H are perspective and top plan views, respectively, of a suspension member of the suspension assembly shown in FIG. 3F. Referring to FIGS. 3A-3H together, the playback device 310 includes an enclosure 316 that is coupled to and carries the audio transducer 314. The enclosure 316 can define an internal chamber and the audio transducer 314 can couple with the enclosure 316 so that at least a part of the audio transducer 314 is partially disposed within the internal chamber. In some examples, the enclosure 316 is sealed when the audio transducer 314 is mounted within the enclosure 316 so that air cannot move into or out of the internal chamber. The playback device 310 can further include electronics 312, which can be disposed within the internal chamber or otherwise coupled to other components of the playback device 310.

In some examples, the audio transducer 314 includes a frame 316h, which defines the body of the audio transducer 314 and extends around the sides and base of the audio transducer 314. In some examples, when the frame 316h attaches the audio transducer 314 to the enclosure 316, sealing the enclosure 316 and fluidly coupling the audio transducer 314 with the internal chamber. A magnet 326 (FIG. 3C) attached to a lower portion of the frame 316h defines an aperture within which a voice coil 328 is at least partially disposed.

The audio transducer 314 can further include a diaphragm 320 having a radially outer portion coupled to an upper portion of the frame 316h, and a radially inner portion coupled to the voice coil 328. In some examples, a surround 322 resiliently attaches the radially outer portion of the diaphragm 320 to the frame 316h. The audio transducer 314 further includes a dust cap 324, which can be attached to an upper portion of the voice coil 328. In various examples, the diaphragm 320 can comprise a thin sheet of paper, plastic, metal, or other suitable material formed in a generally conical or frustum shape. The surround 322 can comprise a flexible material such as a foam, rubber, or other suitable material that permits the diaphragm 320 to move inward and outward along the axis L1.

In some examples, the audio transducer 314 can include a suspension assembly 349 configured to contribute a negative stiffness to the transducer along the axis L1. This contribution of negative stiffness lowers the overall stiffness of the transducer 314, thereby improving the transducer's 314 efficiency. Although particular implementations of such negative-stiffness suspension assembly 349 are shown and described herein, in various examples other types of negative-stiffness suspension members can be used in addition to or instead of the particular suspension assembly 349 described herein.

In some examples, the suspension assembly 349 can include a central collar 340 configured to be coupled to (e.g., circumferentially surround and be attached to) the voice coil 348, with a plurality of suspension members 350a-f, (collectively referred to as the “suspension members 350”) extending radially outwardly from the collar 340. In various examples, the suspension members 350 can each include a radially inner portion coupled to the voice coil 328 (e.g., via the collar 340) and a radially outer portion coupled to the frame 316h. These suspension members 350 can be springs or spring-like members that are arranged in compression such that they exert a radially inward force against the voice coil 328 while secured to the frame 316h. In some implementations, each suspension member 350 can be configured to protrude either inwardly or outwardly (e.g., along a direction substantially parallel to the axis L1) when placed in compression. Additionally, as best seen in FIGS. 3C and 3D, suspension members 350 can be arranged in alternating configurations with a first suspension member 350a protruding axially outward and the opposing second suspension member 350d protruding axially inward. In some examples, pairs of radially opposed suspension members 350 can protrude axially in alternating directions. Additionally or alternatively, suspension members 350 can alternate the direction of axial protrusion around the radial direction (e.g., with radially adjacent suspension members 350 protruding in opposite axial directions). For example, in the configuration shown in FIGS. 3D and 3E, the suspension members 350a, 350c, and 350e protrude axially outward in their respective intermediate portions, and the suspension members 350b, 350d, and 350f protrude axially inward in their respective intermediate portions. In various examples, the particular orientation and configuration of each suspension member 350 can be varied to achieve the desired operation performance.

At a rest position (e.g., with the suspension members 350 aligned substantially along the axis L2 of FIG. 3C), the radially inward forces provided by the suspension members 350 may cause no movement of the voice coil 328. However, as the voice coil 328 moves outward (e.g., along axis L1 in FIG. 3C), radially inner ends of the suspension members 350 move with the voice coil 328 while the radially outer portions of the suspension members 350 remain coupled to the frame 316h and therefore stationary. In this arrangement, force exerted on the voice coil 328 by the suspension members 350 includes both a radially inward component (e.g., along axis L2) and an axial component (e.g., along axis L1), such that the suspension member 350 urges the voice coil 328 further outward along the axis L1. In a similar fashion, when the voice coil 328 moves inwardly (i.e., along axis L1), the suspension member 350 exerts a force (due to the suspension members 350 being in compression) that urges the voice coil 328 further inwardly.

In several examples, the suspension members 350 can be evenly distributed within the audio transducer 314 such that the suspension members 350 remain substantially equidistant from one another (e.g., the suspension members 350 can be substantially evenly spaced apart circumferentially around the voice coil 328). Additionally, or alternatively, one suspension member 350 can be positioned within the audio transducer 314 so that another suspension member 350 is positioned on an opposing side of the voice coil 328. In such configurations, the radially inward force exerted by each suspension member 350 can be substantially canceled out by the radially inward force exerted by the other suspension members 350. As such, there may be no net radial force exerted on the voice coil 328 by the combination of suspension members 350. In one example, as illustrated in FIG. 3D, the suspension member 350a is positioned on a first side of the voice coil 328 while the suspension member 350d is positioned on a second side of the voice coil 328 that opposes the first side. The suspension members 350 can impart a negative stiffness value to the transducer (as measured along the axis L1) and can also include one or more stress distributing features.

In the illustrated example, the suspension members 350 are arranged substantially aligned along a radial plane (e.g, along axis L2 when at rest at a neutral position). However, in various examples one or more of the suspension members 350 can be offset from one another along axis L1, for example having a first pair of suspension members 350 positioned above a second pair of suspension members 350. Opposing pairs of suspension members 350 can be arranged in the same plane or may be offset from one another along the axis L1. In various examples, a first pair of suspension members 350 and a second pair of suspension members 350 can be axially offset from one another (e.g., spaced apart from one another along axis L1). Additionally, the radial arrangement of such axially spaced pairs can be configured such that the one or both of the first pair of suspension members 350 is radially separated from the corresponding suspension members 350 of the second pair. In some examples, the radial arrangement of such axially spaced pairs can be configured such that the one or both of the first pair of suspension members 350 at least partially overlaps the corresponding suspension members 350 of the second pair.

Additionally or alternatively, in some instances the suspension members 350 may not be arranged in opposing pairs but may otherwise be spaced circumferentially about the voice coil 328 in a manner that achieves an overall balanced radial force (e.g., substantially evenly spaced circumferentially or any other suitable arrangement). In various examples, the total number of suspension members 350 can vary. While the illustrated example shows 6 suspension members 350, in various implementations there may be 2, 3, 4, 5, 7, 8, 9, 10, or more suspension members 350 distributed about the voice coil 348.

Optionally, the playback device 310 may include one or more stabilizers 330 (FIG. 3A). The stabilizer(s) 330 can include one or more components that facilitate the appropriate position, movement, and operation of various components of the transducer 314, such as a diaphragm 320. The stabilizer 330 can couple to the enclosure 316 and be at least partially disposed within the internal chamber. In some examples, the stabilizer 330 can be disposed external to the internal chamber. The stabilizer 330 can be communicatively coupled to the electronics 312 so that the stabilizer 330 can receive commands or other signals from the electronics 312. In some examples, the stabilizer 330 can include a pump, a pneumatic valve, or a positioner configured to mechanically engage the voice coil or other component of the transducer 314 to move the diaphragm into a desired position. Additionally, or alternatively, the stabilizer can include one or more sensors and one or more control members.

In various examples, the playback device 310 can include other components 310j in addition to components described herein. For instance, the playback device 310 can include a user interface, an input/output, and/or any other desired component. In some examples, the enclosure 316 can take the form of a housing. Additionally, or alternatively, the internal chamber can take the form of a cavity. In various examples, the audio transducer 314 can include other components 314j. For instance, the audio transducer can include one or more tinsel leads coupled with the voice coil 328 and the frame 316h that are configured to electrically connect to the transducer 314 to an amplifier or other driving electronics.

FIG. 3F illustrates a perspective view of the suspension assembly 349 separate from the transducer 314, and FIGS. 3G and 3H illustrate perspective and top plan views, respectively, of an isolated suspension member 350a. Referring to FIGS. 3F-3H together, the suspension member 350a can include a body 351 having a first end portion 356 and a second end portion 358 opposite the first end portion 356. Along an intermediate portion 364, the body 351 can protrude along an axial direction (e.g., substantially parallel to axis L1 of FIG. 3C when installed within the transducer 314). Although the illustrated suspension member 350a protrudes axially outward, as noted previously various suspension members 350 may protrude axially inwardly (i.e., in an opposite direction from the axially outwardly protruding suspension member 350a).

In some examples, the first end portion 356 can take the form of a radially outer portion and the second end portion 358 can take the form of a radially inner portion. The first end portion 356 can include a first aperture 357 configured to mate with a component of the transducer 314 via a fastener or other coupling mechanism, and the second end portion 358 can include a second aperture 359 configured to mate with another component the transducer 314 via a fastener or other coupling mechanism. Although the illustrated example utilizes apertures 357, 359 to secure the suspension member 350 to the transducer, in various implementations other coupling mechanisms can be employed. For example, either or both ends of the suspension member 350 can be attached to the frame 314h, the collar 340, and/or the voice coil 328 via use of adhesives, welding, a friction fit engagement, or any other suitable coupling mechanism. In some examples, the suspension members can be integrally formed with the collar 340 and/or with the voice coil 328.

The body 351 can include a corrugated portion 360. The corrugated portion 360 can form a wave-like structure in which the body 351 forms a series of grooves and ridges. In some examples, the corrugated portion 360 forms 1, 2, 3, 4, 5, 6, 7, 8, 9, 10, or more ridges and 1, 2, 3, 4, 5, 6, 7, 8, 9, 10, or more grooves. In several examples, the corrugated portion 360 can take the form of an undulating portion, for example having a generally serpentine or sinusoidal cross-sectional shape. In various examples, the corrugated portion 360 is positioned between the first and second end portions 356, 358. The corrugated portion 360 can include some or all of the protruding intermediate portion 364.

The suspension member 350 can have a varied width across the length of the body 351. For example, the suspension member 350 can include one or more narrowed portions formed along the length of the body 351. As illustrated in FIG. 3H, the suspension member 350 defines a first narrowed portion 362 and a second narrowed portion 366 along the length of the body 351. The first and second narrowed portions 362, 366 can include a first width W1 that is narrower than other portions of the body 351 having a second width W2. For instance, the first and second narrowed portions 362, 366 can each have a width that is less than the width of the first and second end portions 356, 358. In some examples, the width of one or both of the narrowed portions 362, 366 is 5%, 10%, 15%, 20%, 25%, 30%, 35%, 40%, 45%, or 50% less than the maximum width of the first or second member 352, 354. In various examples, the width of one or both of the narrowed portions 362, 366 have a continuous slope across the length of the narrowed portion 362. In several examples, the first and second narrowed portions 362, 366 can be spaced apart from each other such that a wider (or narrower) portion is positioned between the first and second narrowed portions 362, 366. For instance, as illustrated in FIG. 3H, an intermediate portion 364 can be positioned between the first and second narrowed portions 362, 366, with the intermediate portion 364 having a third width W3 different than (e.g., wider or narrower than) either or both of the first and second narrowed portions 362, 366. In certain examples, other portions of the suspension members 350 optionally have different widths than W1, W2, and/or W3. For instance, as shown in FIG. 3H, an intervening portion 363 between the narrowed portion 362 and the intermediate portion 364 has a fourth width W4 different than (e.g., wider or narrower than) any of the widths W1, W2, and/or W3. In other examples, however, the suspension members 350 have a generally consistent width such that the widths W1, W2, W3 and W4 are approximately the same.

In various examples, first and second narrowed portions 362, 366 and the intermediate portion 364 can be formed along the corrugated portion 360 of the body 351. In several examples, the largest width of the suspension members 350 can be at the intermediate portion 364. Additionally, or alternatively, the intermediate portion 364 can have a width that is 5%, 10%, 15%, 20%, 25%, 30%, 35%, 40%, 45%, or 50% larger than the smallest width at the first and second narrowed portions 362, 366.

As previously noted, the suspension member 350 can be attached to the frame 316h at a first end and attached to the collar 340 and/or the voice coil 328 at its second end. In some examples, the suspension members 350 can be fixed to the frame via a fastener 344. In the illustrated example, the collar 340 is disposed around an outer surface of the voice coil 328 and can be attached thereto (e.g., via welding, adhesive, or being integrally formed with a voice coil former). In at least some instances, the suspension member(s) 350 and the collar 340 can be integrally formed as a single component. In some examples, when the suspension members 350 are at rest (e.g., the voice coil 328 is not moving) the suspension members 350 can extend in a direction that intersects the voice coil's direction of travel. For instance, the suspension members 350 can extend along the axis L2 while the transducer is at rest, which intersect the voice coil's direction of travel along the axis L1 (FIG. 3C).

When coupled to the voice coil 328, the collar 340 can be configured to move with the voice coil 328 during operation. For example, when the voice coil 328 moves in a first direction, the collar 340 can also move in the first direction with the voice coil 328. When coupled to the collar 340, the suspension members 350 can also be configured to move with the voice coil 328 during operation. For example, when the voice coil 328 moves along the axis L1 (e.g., in a first or second direction along the axis L1), the suspension member 350 can also move along the axis L1 with the voice coil 328. In some examples, only a portion of the suspension member 350 moves with the voice coil 328 during operation. For instance, the first end portion 356 of the suspension member 350 can be fixed to the frame 316h and remain stationary relative to the other portions of the suspension member 350 while the first member 352, the second member 354, and the second end portion 358 can move in response to any movement from the voice coil 328.

The suspension members 350 can keep some of the components within the audio transducer 314 properly positioned during operation. For instance, the suspension member 350 can keep the voice coil 328 properly aligned with the magnet 326. The suspension members 350 can have a stiffness, which represents the ability of the suspension members 350 to resist displacement from an applied force. This stiffness can be a positive value, meaning the suspension members 350 resist the applied force by responding with a counteracting force in the opposite direction of the applied force. In some examples, the stiffness can have a negative value (e.g., a negative stiffness). When the suspension members 350 have a negative stiffness, the suspension members 350 respond to an applied force with an additional displacement in the same direction of the applied force.

In some examples, the suspension members 350 are arranged within the transducer such that the bodies 351 of the suspension members 350 are in compression. For instance, the body 351 can be compressed along the axis L2, and/or perpendicular to the axis L1 (FIG. 3C) when the transducer 314 is at rest. By compressing the suspension members 350 in this manner, the suspension members 350 will have a negative stiffness along the axis L1. As a result of this configuration, the suspension members 350 respond to a displacement resulting from an applied force along the axis L1 with an additional force in the same direction as the applied force (e.g., the suspension member is biased to move in the same direction as the applied force). For example, when a force is applied to the suspension member 350 along the axis L1, the compressed suspension member 350 causes the suspension member 350 to move in the same direction as the applied force.

Because the suspension members 350 are biased to move along the axis L1 once displaced from a stable rest position, the suspension members 350 can reduce the amount of power that is required to operate the audio transducer 314. When the voice coil 328 moves in a particular direction along the axis L1, the suspension members 350 will bias the voice coil 328 in its direction of travel, which counteracts the stiffness caused from the surrounding air and other components within the audio transducer 314. Accordingly, the audio transducer 314 can be more efficient when utilizing one or more suspension members 350.

In some examples, the total stiffness of the playback device 310 (e.g., the stiffness of all the components of the playback device 310 and the stiffness of the air within the internal chamber of the enclosure 316) can be tuned to a desired value. By tuning the total stiffness of the playback device 310, the resonant frequency of the playback device 310 can also be adjusted accordingly. For example, lowering the total stiffness of the playback device 310 would lower the resonant frequency of the playback device 310. In contrast, increasing the total stiffness of the playback device 310 would increase the resonant frequency of the playback device 310. Thus, by being able to tune the total stiffness, a user can produce a playback device 310 with a desired (or favorable) resonant frequency. In some examples, the amount of negative stiffness included with the system can be adjusted by including or removing additional suspension members 350. For example, a playback device 310 with ten suspension members 350 will have a lower total stiffness than a playback device 310 with four suspension members 350. In some examples, the playback device 310 can include 1, 2, 3, 4, 5, 6, 7, 8, 9, 10, 11, 12, or more suspension members 350. In various examples, the total stiffness can be positive or negative, depending on the desired operating characteristics.

As previously noted, compressing the suspension members 350 can cause high levels of stress within each suspension member 350. This stress is compounded by the movement the suspension member 350 undergoes during operation (e.g., the movement with the voice coil 328 during operation). In some examples, the stress can be so extreme that conventional suspension members would fail under normal operating conditions. To overcome the high levels of stress, the suspension members 350 can include one or more features that distribute the stress across the suspension member 350.

In some examples, the corrugated portions 360 can distribute the stress across the suspension member 350. By including the corrugated portions 360, stress within the suspension member 350 does not concentrate at one particular area but can be more evenly distributed across the length of the corrugated portions 360. In several examples, the narrowed portions 362, 366 can reduce the amount of stress at a particular area along the length of the suspension member 350. By including the narrowed portions 362, 366, the concentration of stress at the narrowed portions 362, 366, at the center of the suspension member 350, and at the first and second end portions 356, 358 is greatly reduced. Additionally, or alternatively, including a wider intermediate portion 364 can reduce the amount of stress at a particular area along the length of the suspension member 350. For example, including an intermediate portion 364 that is wider than the surrounding portions of the suspension member 350 can reduce the concentration of stress at any particular point on the intermediate portion 364.

In addition to the features for distributing stress, the suspension members 350 can be sized and configured in a manner that reduces the levels of stress across the suspension members 350. In some examples, the body 351 of the suspension members 350 can have a thickness between 0.2 mm to 0.05 mm (e.g., approximately 0.1 mm). In some examples, the body 351 can have an average width between 1 mm to 15 mm (e.g., an average width of about 9.5 mm). Having a thickness and width within these ranges allows for the suspension member 350 to retain enough flexibility for operation while also retaining enough rigidity to manage the stress of operation.

According to some examples, some or all of the suspension members 350 can be made of a material having a high stiffness and relatively low mass. Example materials can include composite materials such as reinforced plastics (e.g., reinforced with carbon fibers, carbon nanotubes, etc.), or optionally stainless steel, other metals or metal alloys, or any other suitable material. In some examples, each suspension member 350 can include one or more layers of carbon-fiber reinforced plastic material. Using carbon-fiber reinforced plastics can achieve better performance and/or reliability and simplify fabrication as compared to forming suspension members 350 from metal. Optionally, the suspension member 350 can include two or more layers of such carbon-fiber reinforced plastic material in which the orientation of the carbon fibers vary between the layers. For example, in a three-layer arrangement, the top and bottom layers may have carbon fibers arranged along the long axis of the suspension member 350, with a middle layer having carbon fibers arranged along a perpendicular axis (e.g., along a width axis or along a thickness axis perpendicular to the width axis and the longitudinal axis). This configuration can provide a high stiffness along the long axis of the suspension member 350 while maintaining high durability and relatively low mass. Any suitable combination of layers, orientation of the carbon-fibers, or combinations of materials can be used to achieve the desired material properties of the suspension members 350.

### B. Example Pre-Loaded Suspension Assemblies

In negative-stiffness audio transducers, the stiffness of spring members or other suspension members can be a key variable affecting operation of the device. As described previously, a suspension assembly can include a plurality of spring members arranged circumferentially around a voice coil of the transducer and coupled to a surrounding annular frame. The individual spring members can be placed in compression and configured such that, at a neutral rest position, the radially inward forces supplied by each of the spring members cancels out in both radial and axial directions. As the voice coil moves axially inward or outward, radially inner portions of the spring members move with the voice coil, and due to the compression, the spring members together exert an additional axial force in the same direction of movement. This additional axial force thereby imparts the negative stiffness to axial movement of the voice coil (and other components such as the diaphragm).

Successful operation of such a negative-stiffness transducer can depend on the compression of each spring member falling within an optimum range, as too little compression will not impart sufficient axial force to facilitate excursion of the diaphragm, and too much compression may impart too much axial force, leading to excursion beyond desired limits. Additionally, the compression of each spring member should be tailored such that the forces of all the spring members are balanced in both the axial direction (when at the neutral rest position) and in the radial direction (both when the transducer is at rest and as it moves through its excursion range). Imbalance along either dimension can lead to distortion and/or inefficient movement of the transducer through its excursion range. The force of each spring member is a factor of the material composition of the spring member (e.g., stainless steel, carbon fiber reinforced plastic, etc.), the shape of the spring member (e.g., corrugated, arc-shaped, thickness, width, etc.), and the configuration in which the spring member is placed within the transducer. For example, as the radially inner and radially outer ends of the spring member are brought closer together in the assembled configuration, the reaction force of the spring member increases. Conversely, as the radially inner and radially outer ends of the spring member are moved further apart, the reaction force decreases.

Such relative positioning of the inner and outer ends can be determined by the mounting components of the suspension assembly. For example, in some implementations, the radially inner end portion of the spring member can be attached to a collar, which in turn is mounted to a voice coil. Additionally or alternatively, the radially inner end portion of the spring member can be directly coupled to the voice coil, or otherwise indirectly coupled to the voice coil. The radially outer end portion of the spring member can be coupled to a surrounding frame (e.g., an annular frame), which can be coupled to or integrated with other components of the transducer, such as the basket. Ideally, when each spring member is mounted with its radially inner end portion coupled to the voice coil and its radially outer end portion coupled to the surrounding frame, the radial and axial forces are balanced.

In practice, it can be difficult to correctly assemble such a negative-stiffness suspension assembly in which a plurality of spring members have radially inner end portions coupled to an inner collar (or to the voice coil) and radially outer end portions coupled to a surrounding annular frame. In some instances, the spring members themselves may be quite fragile under manual manipulation, and hence manually moving the spring members into position can risk damaging or even breaking the spring members. Carbon fiber reinforced plastic spring members may be particularly susceptible to such damage since, depending on the particular configuration, such spring members may be quite strong in one direction (e.g., along the long axis of the spring member) while being relatively weak in other directions (e.g., across the width of the spring member). Some aspects of the present technology address these and other problems by providing attachment features disposed at the radially outer end portions of the spring members. These attachment features can define hooks, loops, recesses, protrusions, or other mechanical mating structures that are configured to reliably mate with and engage the annular frame, thereby providing a consistent compression for each spring.

In some implementations, a pre-load fixture can be used to assemble the suspension assembly. The pre-load fixture can include one or more compressive devices (e.g., linear actuators) that can releasably engage the attachment features and urge them radially inwardly to place the spring members in compression, after which the annular frame can be placed into engagement with the attachment features. In some instances, each compressive device is configured to move its corresponding attachment feature over a predefined distance and/or to a predefined radial position, thereby achieving a desired compression level for that spring member. Optionally, the annular frame can then be fastened to the attachment features using screws, clamps, adhesive, or other mechanisms. Once each of the spring members are secured to both the inner collar and the surrounding annular frame, this pre-loaded suspension assembly can be provided for incorporation into a completed audio transducer.

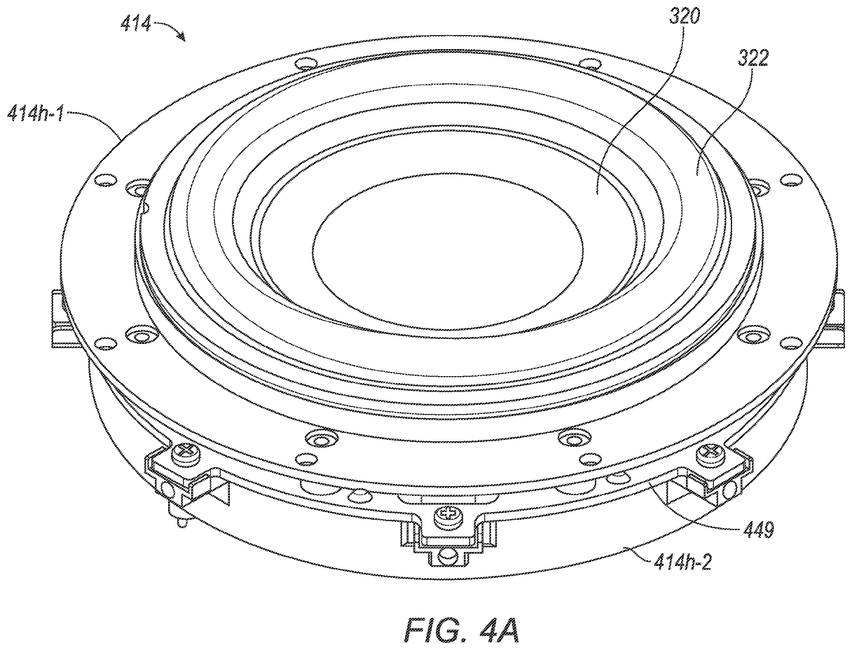

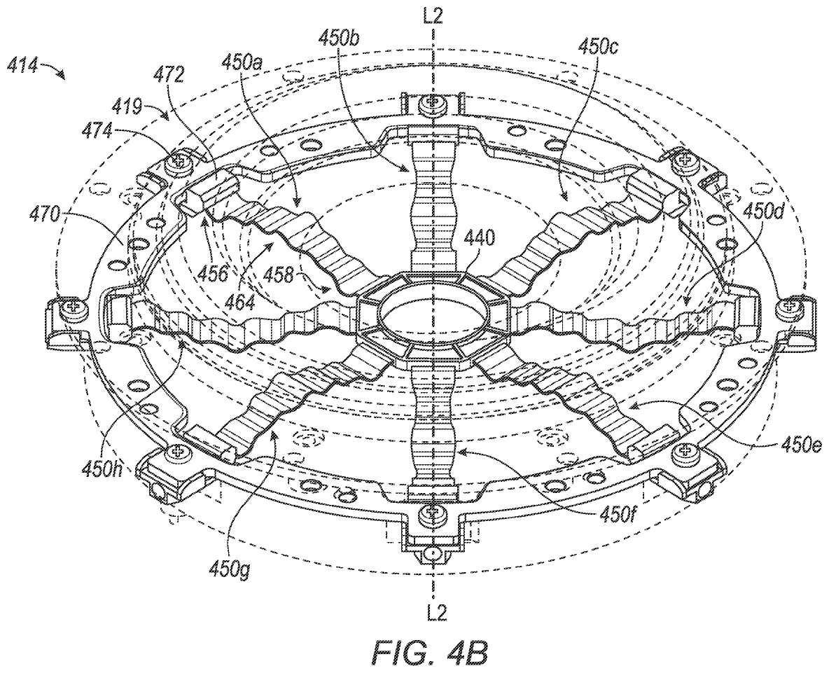

FIG. 4A is a perspective view of a portion of a negative-stiffness transducer 414 with several components omitted for clarity. FIG. 4B is a perspective view of the transducer 414 shown in FIG. 4A with several components shown transparently so as to better illustrate the isolated suspension assembly 449. The transducer 414 can include some or all of the features and components described previously herein with respect to FIGS. 3A-3E, and any of the features or components shown and described with respect to FIGS. 3A-3E can be applied to the transducer 414 shown in FIGS. 4A and 4B. For example, the suspension members 450 can be corrugated, formed of carbon fiber reinforced plastic, or include any other aspect of the suspension members 350 described above.

As shown in FIG. 4A, the transducer 414 includes a diaphragm 420 coupled to a circumferential surround 432. The surround 432 is coupled to an annular upper basket portion 414h-1. A lower basket portion 414h-2 is spaced apart from the upper basket portion 414h-1 along the axial direction, with the suspension assembly 449 sandwiched therebetween.

As best seen in FIG. 4B, the suspension assembly 449 includes a central collar 440 which is configured to be coupled to (e.g., circumferentially surround and be attached to) a voice coil (not shown), which in turn can be coupled to the diaphragm 420. A plurality of suspension members 450a-h (collectively referred to as “suspension members 450”) each have a radially inner end portion 458 coupled to the collar 440 and a radially outer end portion 456 coupled to an annular frame 470. In some implementations, the central collar 440 can be overmolded over each of the inner end portions 458 of the suspension members 450. In various examples, the radially inner end portions 458 can be coupled to the separately formed collar 440 via adhesive, welding, fasteners such as screws or bolts, or any other suitable technique. In alternative implementations, the frame 470 can be replaced with other components of the transducer 414, such as a portion of the basket or other suitable structure.

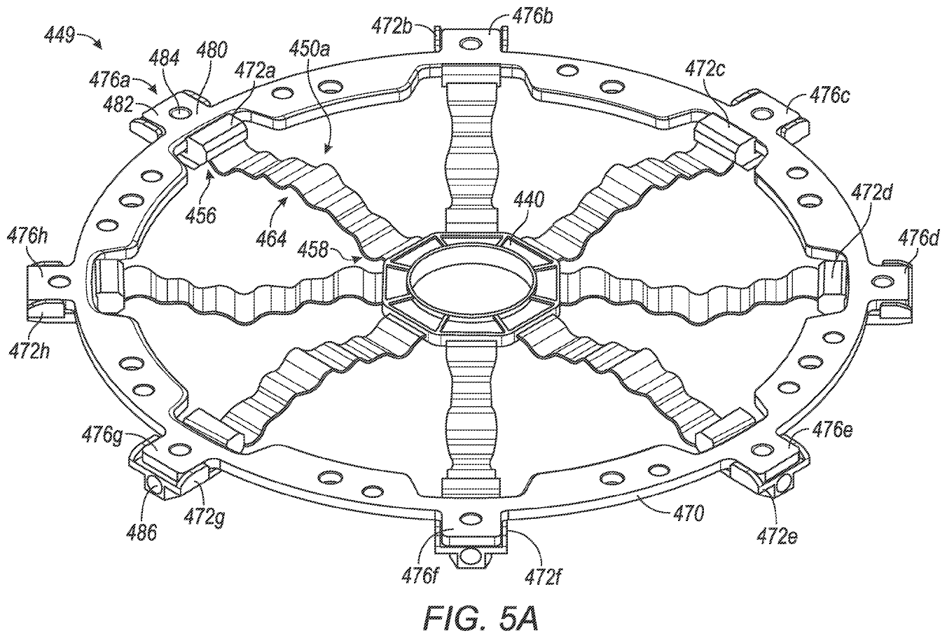

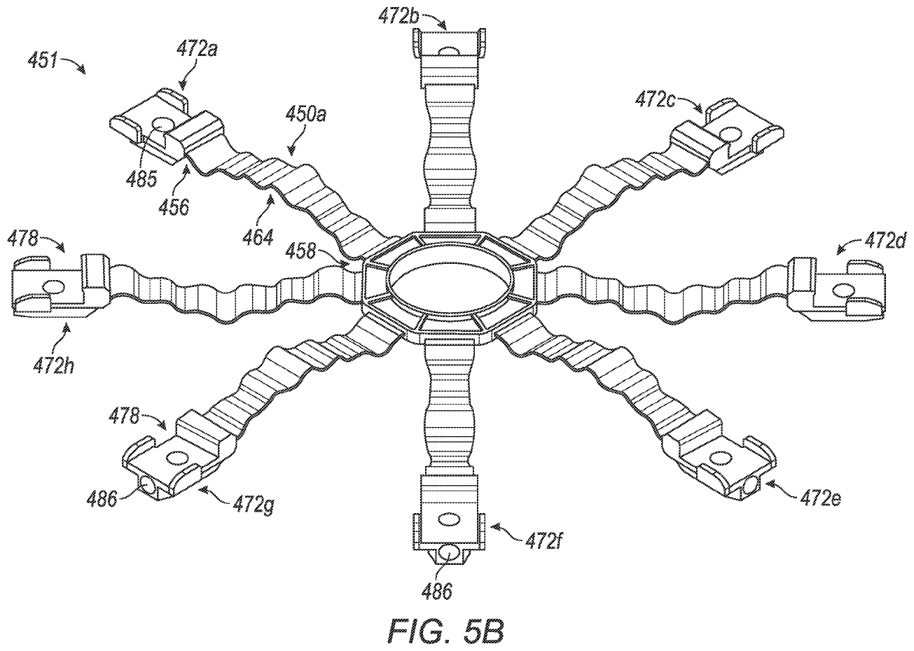

The radially outer end portions 456 of the suspension members 450 can be coupled to the annular frame 470 via attachment features 472. Each attachment feature 472 can be coupled to (e.g., attached to, integrally formed with, or otherwise coupled to) a radially outer end portion 456 of a suspension member 450. These attachment features 472 can be configured to reliably mate with and engage the annular frame 470. In various examples, the attachment features 472 include mechanical features configured to mate with corresponding mechanical features of the annular frame 470. As seen in FIG. 4B, a plurality of fasteners 474 (e.g., screws, bolts, adhesive, etc.) can be used to secure the annular frame 470 to the attachment features 472. In this assembled state, each suspension member 450 can be placed in compression (i.e., exerting a radially inward force on the collar 440). Additional aspects of the attachment features 472 are described below with respect to FIGS. 5A and 5B.

With continued reference to FIGS. 4A and 4B, the suspension members 450 can include an intermediate portion 464 between the outer end portion 456 and inner end portion 458, and the suspension members 450 can be configured such that the intermediate portion 464 protrudes along the axial direction (e.g., along a direction parallel to axis L2 extending through a centerline of the collar 440). In the illustration configuration, the suspension members 450 are arranged in an alternating fashion around the collar 440 such that alternating suspension members have an intermediate portion 464 that either protrudes axially upward (suspension members 450a, 450c, 450e, and 450g) or axially downward (suspension members 450b, 450d, 450f, and 450h). In various implementations, the number and arrangement of the various suspension members can vary, for example having fewer or more suspension members, varying the circumferential spacing between elements, or making other suitable modifications.

As shown in FIG. 4A, in the assembled transducer 414, the suspension assembly 449 can be secured to the upper and lower basket portions 414h-1 and 414h-2, which can in turn be coupled to a surrounding enclosure or other frame components. As such, the radially outer portion of the suspension assembly 449 can be substantially fixed in place, while the radially inner portion (e.g., the collar 440 and the radially inner ends 458 of the suspension members 450) can be free to move along with the voice coil (not shown) and the diaphragm 320.

FIG. 5A is a perspective view of the suspension assembly 449 in an assembled (e.g., pre-loaded) configuration, and FIG. 5B is a perspective view an unloaded suspension sub-assembly 451, which includes the collar 440 and suspension members 450 of the suspension assembly 449 but does not include the annular frame 470. With reference to FIGS. 5A and 5B together, each of the suspension members 450 includes a corresponding attachment feature 472a-h (collectively “attachment features 472”) disposed at a radially outer end portion 456. Each attachment feature 472 can be securely coupled to a corresponding attachment portion 476a-h (collectively “attachment portions 476”) of the annular frame 470. In various examples, each attachment features 472 can include a first mating feature and each attachment portion 476 of the annular frame 470 can include a corresponding second mating feature configured to securely engage with a first mating feature. According to various implementations, the first and/or second mating features can take the form of recesses, channels, grooves, detents, hooks, loops, ridges, protrusions, flanges, or any other suitable shape or structure that provides reliable mechanical engagement. In various examples, mating of these two features can limit relative movement between the frame 470 and the attachment features 472 along circumferential and axial directions, while still permitting some movement along the radial direction. As described in more detail below, at rest the suspension members 450 may extend further radially outward beyond the frame. To secure the suspension members 450 to the frame, the attachment features 472 of each suspension member may be forced radially inwardly, placing the suspension member 450 in compression, until the attachment features 472 are appropriately aligned with respect to the attachment portions 476 of the frame 470. By utilizing mating features that maintain alignment while permitting relative movement in the radial direction, assembly of the suspension assembly 449 is made more reliable and repeatable.

In the illustrated example, the attachment features 472 each includes a recess 478 (e.g., a first mating feature) and the attachment portions 476 of the annular frame 470 each includes a semi-annular segment 480 configured to be received within the recess 478. When the segment 480 of the annular frame 470 is securely positioned within the recess 478 of the attachment feature 472, the radially outer end portion 456 of the suspension member 450 can be substantially fixed with respect to the frame 470. When each of the suspension members 450 is so secured to the surrounding annular frame 470 via its corresponding attachment features 472, the radially outer end portions 456 of the suspension members 450 are fixed and the suspension members 450 are placed in compression, resulting in a radially inward force on the collar 440. As noted previously, arrangement of the suspension members 450 can be selected such that these radially inward forces substantially cancel out when the suspension assembly 449 is at a rest position (i.e., the collar 440 lies substantially within the same plane as the annular frame 470).

The attachment portions 476 of the annular frame 470 can each include a tab 482 extending radially outward from the segment 480 and configured to overlie a portion of the attachment feature 472. The tab 482 can define an aperture 484 through which a fastener can be inserted. When the attachment portions 476 of the frame 470 are placed within the corresponding recesses 478 of the attachment features 472, the aperture 484 in the tab 482 of the annular frame 470 can be aligned with an underlying opening 485 in the attachment feature. This opening can be a threaded receptacle, for example, to allow a fastener such as a screw to be inserted therethrough to securely affix the frame 470 to the attachment feature 472.

As noted above, the attachment features 472 can facilitate assembly of suspension assembly 449 by providing for a secure, reliable coupling between the radially outer end portions 456 of the suspension members 450 and the annular frame 470. The attachment features 472 and the annular frame 470 can be configured such that mating of the two together achieves proper radial position of the outer end portions 456 of the suspension members 450 (e.g., secured at the desired radial distance away from the collar 440) as well as proper circumferential spacing of the suspension members 450 around the collar 440.

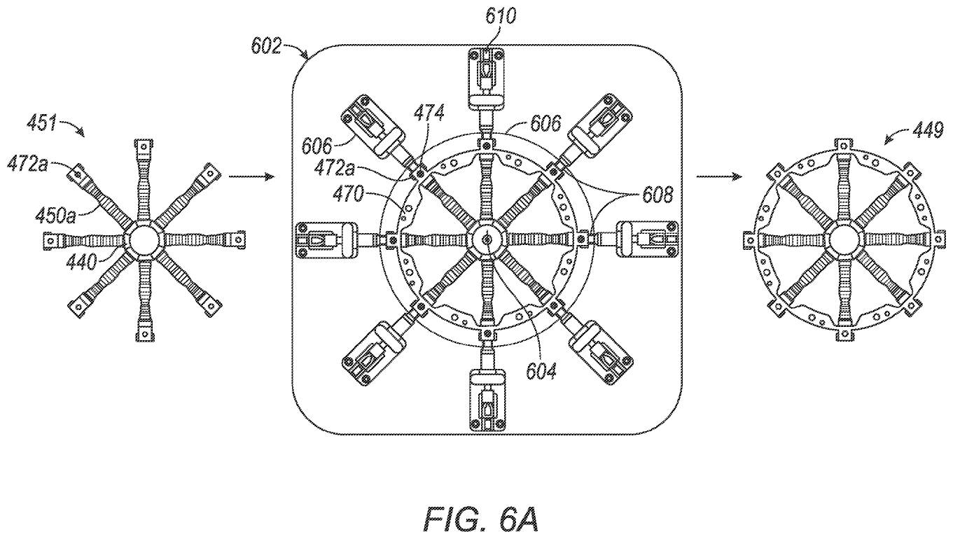

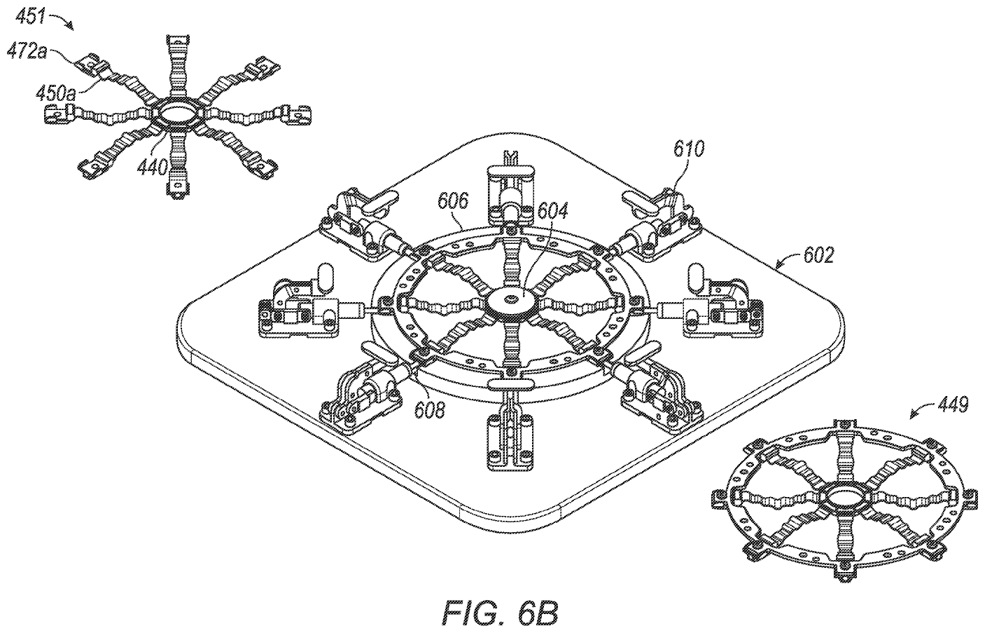

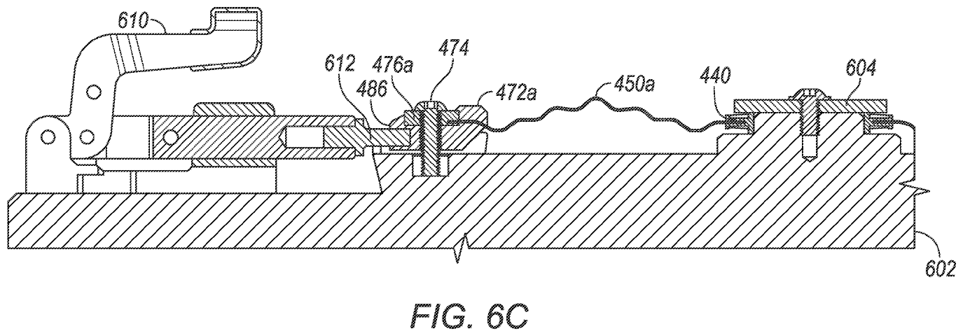

In some examples, the attachment features 472 can also include an interface 486 for engaging with a compressive device (not shown). While it may be possible to manually couple each attachment feature 472 to its corresponding attachment portion 476 of the frame 470, doing so may risk damage to the suspension members 450 and/or improper alignment of the suspension members 450. As such, it may be beneficial to utilize compressive devices (e.g., a linear actuator) that can engage the attachment feature 472 and provide a radially inward force thereon until the attachment feature is positioned in a desired manner (e.g., having a desired level of compression). In the illustrated example shown in FIGS. 5A and 5B, this interface 486 takes the form of a receptacle disposed on a radially outer surface of the attachment feature 472. In operation, and as described in more detail below with respect to FIGS. 6A-8B, a compressive device can engage the interface 486 (e.g., a portion of the compressive device can be inserted into the receptacle) to urge the attachment feature 472 in a radially inward direction. By mounting unloaded components of the suspension assembly 449 (as shown in FIG. 5B) onto a pre-loading fixture and using compressive devices to drive the attachment features 472 radially inwardly, the attachment features 472 can be driven to the appropriate positions to receive the annular frame 470 thereon.

FIG. 6A is a schematic top view of a pre-loading process for a suspension assembly 449 using a pre-loading fixture 602, and FIG. 6B is a perspective view of the pre-loading process shown in FIG. 6A. FIG. 6C illustrates a side view of a portion of the suspension assembly 449 mounted onto the pre-loading fixture 602. With reference to FIGS. 6A-6C together, a suspension member sub-assembly 451 is provided. The suspension member sub-assembly 451 includes the inner collar 440, the plurality of suspension members 450, and the plurality of corresponding attachment features 472 disposed at radially outer ends of the suspension members 450. The sub-assembly 450 may initially be in an unstressed, relaxed configuration, in which the suspension members 450 are permitted to expand to their rest length. To place the suspension members 450 in compression and to secure the annular frame 470, the sub-assembly 451 can be placed on a pre-loading fixture 602. The pre-loading fixture 602 can include surface features defining a central region in which the collar 440 is received. A cap 604 can be positioned over the collar 440 and secured to a base of the pre-loading fixture 602 to secure the collar 440 in position. The pre-loading fixture 602 also includes an annular ridge 606 having a plurality of recesses 608 configured to receive the attachment features 472 therein. A plurality of compressive devices 610 are arranged circumferentially around the annular ridge 606 and aligned with the recesses 608 such that each compressive device 610 can engage a corresponding attachment feature 472. The compressive devices 610 can be any suitable actuators (e.g., manual driving clamps, pneumatic cylinders, solenoids, motorized lead screws, etc.) that can reliably move the attachment features 472 in a radially inward direction over a controlled distance and/or to a desired amount of compression. In one example, the compressive devices 610 can be configured to move each attachment feature 472 over a predetermined distance of about 4 mm, resulting in a pre-load force of approximately 40 N per suspension member 450. As one of skill in the art will understand, larger travel distances will generally lead to higher pre-load forces and vice versa. Moreover, the particular forces and distances will depend on the size and configuration of the transducer, the composition, shape, and arrangement of the suspension members 450, etc.

As best seen in FIG. 6C, the compressive device 610 can engage the attachment feature 472, for example via interface 486 (e.g., a receptacle). A protruding rod 612 of the compressive device 610 can be moved linearly in a controlled fashion in a radially inward direction toward the collar 440 and cap 604, thereby exerting a compressive force on the suspension member 450a. Once the compressive device 610 has moved the attachment feature 472a of the suspension member 450a to the appropriate position (and the other compressive devices 610 have similarly moved their corresponding attachment features 472 to appropriate positions), the annular frame 470 can be mated with the attachment features 472, such that the attachment portion 476a of the frame 470 mates with the attachment feature 472a of the suspension member 450a. Next, a fastener 474 can be used to further secure annular frame 470 to the attachment feature 472. Once each attachment feature 472 has been secured to the frame 470, the resulting pre-loaded suspension assembly 449 can be removed from the pre-loading fixture 602 (e.g., the compressive devices 610 can be disengaged from the attachment features 472 and the cap 604 can be removed from its position on top of the collar 440).

The compressive force applied via the compressive devices 610 to position the attachment features 472 at the appropriate positions may vary according to the transducer design. Similarly, the resulting compressive force applied by each suspension member 450 can vary according to the transducer design. In some implementations, the radial compressive force for each suspension member 450 in the pre-loaded configuration can be greater than an axial force for each suspension member 450 by a factor of at least 2, 3, 4, 5 or more.

Under ideal conditions, each spring member is manufactured according to predefined specifications such that arrangement of the spring members into the suspension assembly (with a radially inner end coupled to a collar and a radially outer end coupled to an annular frame) leads to the desired balance. However, in some instances, such as due to manufacturing variability of one or more components of the suspension assembly, in the assembled state the spring members may be imbalanced (e.g., with the suspension assembly providing a net axial force on the collar when at the rest position and/or providing a net radial force on the collar in one direction). Some aspects of the present technology address these problems by providing attachment features coupled to the spring members that enable fine-tuned adjustment of the position at which the radially outer end portion of the spring is coupled to the annular frame. For example, an actuator including a ratchet, a leadscrew, or other mechanism can be used to variably control the position of the radially outer end portion of each spring independently.

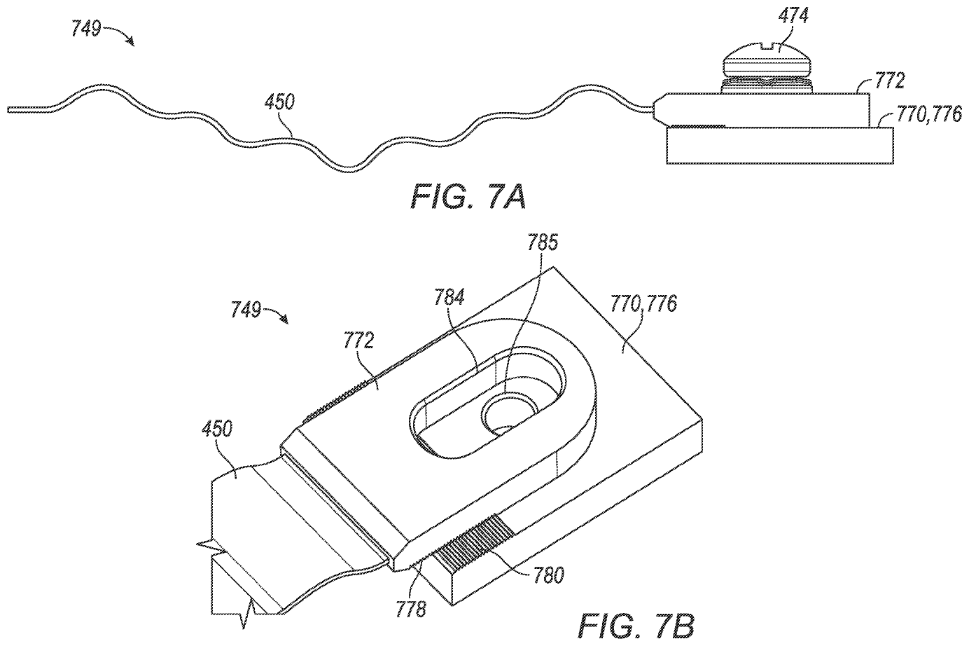

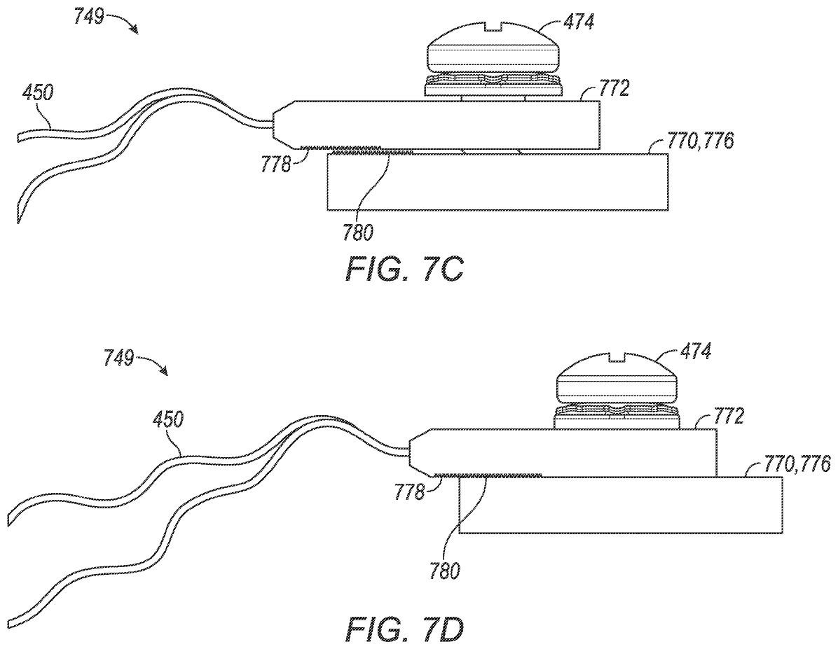

FIGS. 7A and 7B are side and top perspective views, respectively, of a portion of an example suspension assembly 749 during a pre-loading process. FIGS. 7C and 7D illustrate side views of a portion of the suspension assembly 749 shown in FIGS. 7A and 7B in unsecured and secured configurations, respectively. With reference to FIGS. 7A-7D together, a suspension member 450 is coupled at one end to an attachment feature 772, which is configured to be positioned on top of an attachment portion 776 of an annular frame 770. The attachment feature 772 includes an aperture 784 configured to overlie and align with an underlying opening 785 in the attachment portion 776 of the frame 770. A fastener 474 (e.g., a threaded screw, bolt, etc.) can be inserted through the aperture 784 and into engagement with the opening 785. As best seen in FIG. 7B, the aperture 784 of the attachment feature 772 is longer in the radial direction than the underlying opening 785 in the attachment portion 776 of the frame 770. Accordingly, there is a linear range of engagement between the attachment feature 772 and the attachment portion 776 of the frame 770 over which the two components can be mated together and secured via a fastener inserted through the aperture 784 and the opening 785. This range of engagement allows for fine-tuned control of the compressive force applied to the suspension member 450, as moving the attachment feature 772 radially inwardly will increase the compressive force applied to the suspension member 450 and moving the attachment feature 772 radially outwardly will decrease the compressive force.

To allow more fine-tuned control of the relative positions of the attachment feature 772 and the frame 770, the attachment feature 772 includes a plurality of first mating features 778 and the attachment portion 776 of the frame 770 includes a plurality of corresponding second mating features 780. These first and second mating features 778 and 780 can be, for instance, corresponding teeth and notches, grooves and ridges, protrusions and recesses, or any other suitable structures. In some implementations, the mating features 778 and 780 allow for incremental engagement such that as the attachment feature 772 is moved radially inwardly relative to the frame 770, a controlled linear movement can be achieved with predefined step sizes (e.g., notches with 0.25 mm pitch may permit linear movement in 0.25 mm increments). In the case of interlocking teeth and notches, for instance, the features 778 and 780 can first be placed in loose engagement, with a fastener 474 only loosing applying downward force on the attachment feature 772. For example, as shown in FIG. 7C, the first mating features 778 on a lower surface of the attachment feature 772 loosely engage the corresponding mating features 780 on an upper surface of the attachment portion 776 of the frame 770. In this arrangement, radially inward or outward force can be applied to the attachment feature 772, causing relative movement of the attachment feature 772 and the frame 720 while some contact between the mating features 778 and 780 remains. This contact may provide auditory feedback of the movement, such as a distinctive clicking sound as corresponding teeth and notches ratchet past one another. As shown in FIG. 7D, once a desired radial position is achieved, the fastener 474 can be tightened, thereby forcing the mating features 778 and 780 into firmer engagement, which no longer allows any relative movement of the attachment feature 772 and the frame 770.

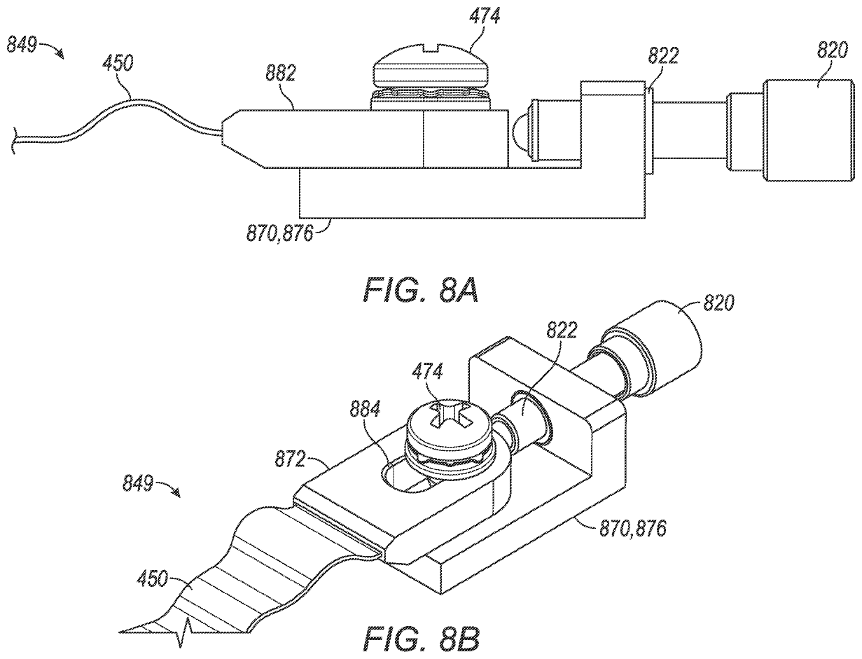

FIGS. 8A and 8B are side and top perspective views, respectively, of a portion of an example suspension assembly 849 during a pre-loading process. As illustrated, a suspension member 450 is coupled at one end to an attachment feature 882, which is configured to be positioned on top of an attachment portion 876 of an annular frame 870. The attachment portion 872 includes an aperture 884 configured to overlie and align with an underlying opening (not shown) in the attachment region 876 of the frame 870. A fastener 474 (e.g., a threaded screw, bolt, etc.) can be inserted through the aperture 884 and into engagement with the frame 870. Similar to the configuration described above with respect to FIG. 7B, since the aperture 884 of the attachment feature 872 is longer in the radial direction than the underlying opening in the attachment region 876 of the frame 870, a linear range of engagement positions is permitted.

This range of engagement allows for fine-tuned control of the compressive force applied to the suspension member 450. However, in the example illustrated in FIGS. 8A and 8B, the fine-tuned control is achieved by use of an adjustment screw 820, which can threadably engage an aperture 822 in the frame 870 and extend into contact with the radially outer surface of the attachment feature 872 of the suspension member 450. By rotating the adjustment screw 820, the attachment feature 872 can be moved radially inwardly or outwardly over a predetermined range until a desired position is reached. Then the fastener 474 can be tightened, securing the attachment feature 872 in place relative to the attachment region 876 of the frame 870. The adjustment screw 820 can then be removed from the frame 870.

In some implementations, the compressive devices (e.g., linear actuators or other suitable structures) used to drive the attachment features radially inwardly can be equipped with sensors to capture data during the pre-loading process. The sensors can include, for instance, load cells, strain gauges, DC motor/back-EMF power monitoring, or other suitable sensors. Depending on the particular compressive device used, the sensors can indicate the amount of compressive force that was applied to place the attachment feature of a suspension member into engagement with the annular ring. As this compressive force will correspond to the reactive force applied by the spring in the pre-loaded state (exerting a radially inward force on the collar and a radially outward force on the frame), the sensor data can indicate the amount of force each suspension member will exert during operation of the transducer. Such data can be used to fine-tune positioning of the attachment features to mechanically balance the suspension members around the suspension assembly. For example, if sensor data indicates that a particular suspension member is exerting a higher reactive force than the other suspension members, then the alignment feature of that suspension member may be moved incrementally radially outwardly with respect to the frame until an appropriate level of compression is achieved. The same principle applies if a particular suspension member is found to have insufficient reactive force.

### IV. Conclusion

The above discussions relating to transducers, playback devices, controller devices, playback zone configurations, and media content sources provide only some examples of operating environments within which functions and methods described below may be implemented. Other operating environments and/or configurations of transducers, media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software examples or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “example” means that a particular feature, structure, or characteristic described in connection with the example can be included in at least one example of an invention. The appearances of this phrase in various places in the specification are not necessarily all referring to the same example, nor are separate or alternative examples mutually exclusive of other examples. As such, the examples described herein, explicitly and implicitly understood by one skilled in the art, can be combined with other examples.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples of the present disclosure can be practiced without certain, specific details. In other instances, well known methods, procedures, components, and circuitry have not been described in detail to avoid unnecessarily obscuring examples of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The disclosed technology is illustrated, for example, according to various examples described below. Various examples of examples of the disclosed technology are described as numbered examples (1, 2, 3, etc.) for convenience. These are provided as examples and do not limit the disclosed technology. It is noted that any of the dependent examples may be combined in any combination, and placed into a respective independent example. The other examples can be presented in a similar manner.
Example 1. An audio transducer, comprising: a frame; a voice coil configured to receive an electrical signal from an amplifier, and, in response to the received electrical signal, correspondingly move a diaphragm inward or outward along an axis; and a suspension assembly coupled to the frame and to the voice coil, wherein the suspension assembly comprises: a first spring having a radially outer end portion coupled to the frame, a radially inner end portion coupled to the voice coil, and an intermediate portion between the outer end portion and the inner end portion, the intermediate portion being displaced in the inward direction from the first end portion and the second end portion; a second spring arranged opposite the first spring with respect to the voice coil, the second spring having a radially outer end portion coupled to the frame, a radially inner end portion coupled to the voice coil, and an intermediate portion between the outer end portion and the inner end portion, the intermediate portion being displaced in the outward direction from the first end portion and the second end portion, wherein the suspension assembly provides a negative stiffness along the axis.
Example 2. The audio transducer of any one of the preceding Examples, wherein the first and second springs are in compression such that the suspension assembly provides a negative stiffness to movement of the diaphragm inward or outward along the axis.
Example 3. The audio transducer of any one of the preceding Examples, wherein the intermediate portions of the first spring and the second spring are each corrugated.
Example 4. The audio transducer of any one of the preceding Examples, wherein the first spring and the second spring each comprises a carbon fiber reinforced plastic material.
Example 5. The audio transducer of any one of the preceding Examples, wherein the suspension assembly further comprises: a third one or more springs each having an outer end portion coupled to the frame, an inner end portion coupled to the voice coil, and an intermediate portion between the outer end portion and the inner end portion, the intermediate portion being displaced in the inward direction; a fourth one or more springs each having an outer end portion coupled to the frame, an inner end portion coupled to the voice coil, and an intermediate portion between the outer end portion and the inner end portion, the intermediate portion being displaced in the inward direction, wherein each of the third one or more springs is arranged opposite the voice coil from a corresponding one of the fourth one or more springs.
Example 6. The audio transducer of any one of the preceding Examples, wherein the springs are evenly spaced apart from one another circumferentially around the voice coil.
Example 7. The audio transducer of any one of the preceding Examples, wherein the third and fourth springs are axially spaced apart from the first and second springs.
Example 8. The audio transducer of any one of the preceding Examples, wherein the third and fourth springs are adjacent the first and second springs, respectively, such that (1) the third and fourth springs are radially separated from the first and second springs, respectively, and (2) the third and fourth springs radially overlap the first and second springs, respectively.
Example 9. The audio transducer of any one of the preceding Examples, wherein the suspension assembly comprises a collar surrounding and coupled to the voice coil, and wherein the inner end portion of the first spring and the inner end portion of the second spring are each affixed to the collar.
Example 10. An audio transducer, comprising: a frame; a voice coil; and a first suspension member having a first end portion coupled to the frame and a second end portion coupled to the voice coil, wherein an intermediate portion between the first end portion and the second portion protrudes along a first direction; a second suspension member having a first end portion coupled to the frame and a second end portion coupled to the voice coil, wherein an intermediate portion between the first end portion and the second portion protrudes along a second direction opposite to the first, wherein the first suspension member and the second suspension member are arranged on opposing sides of the voice coil.
Example 11. The audio transducer of any one of the preceding Examples, wherein the first and second suspension members are in compression such that, together, the first and second suspension members provide a negative stiffness to movement of the voice coil.
Example 12. The audio transducer of any one of the preceding Examples, wherein the intermediate portions of the first suspension member and the second suspension member are each corrugated.
Example 13. The audio transducer of any one of the preceding Examples, wherein the first suspension member and the second suspension member each comprises a carbon fiber reinforced plastic material.
Example 14. The audio transducer of any one of the preceding Examples, further comprising: a third one or more suspension members each having an outer end portion coupled to the frame, an inner end portion coupled to the voice coil, and an intermediate portion between the outer end portion and the inner end portion, the intermediate portion being displaced in the inward direction; a fourth one or more suspension members each having an outer end portion coupled to the frame, an inner end portion coupled to the voice coil, and an intermediate portion between the outer end portion and the inner end portion, the intermediate portion being displaced in the inward direction, wherein each of the third one or more suspension members is arranged opposite the voice coil from a corresponding one of the fourth one or more suspension members.
Example 15. The audio transducer of any one of the preceding Examples, wherein the suspension members are evenly spaced apart from one another circumferentially around the voice coil.
Example 16. The audio transducer of any one of the preceding Examples, further comprising a collar surrounding and coupled to the voice coil, and wherein the inner end portion of the first suspension member and the inner end portion of the second suspension member are each affixed to the collar.
Example 17. A suspension assembly for an audio transducer, the suspension assembly comprising: a collar configured to circumferentially surround a voice coil of the audio transducer; a first spring having an inner end portion coupled to the collar and an outer end portion configured to be coupled to a frame of the audio transducer, wherein an intermediate portion between the inner end portion and the outer end portion protrudes in first direction; a second spring arranged on an opposing side of the collar with respect to the first spring, the second spring having an inner end portion coupled to the collar and an outer end portion configured to be coupled to the frame of the audio transducer, wherein an intermediate portion between the inner end portion and the outer end portion protrudes in second direction opposite the first.
Example 18. The suspension assembly of any one of the preceding Examples, wherein the first and second springs are sized and configured to be in compression when coupled to the frame of the audio transducer.
Example 19. The suspension assembly of any one of the preceding Examples, wherein the intermediate portions of the first spring and the second spring are each corrugated.
Example 20. The suspension assembly of any one of the preceding Examples, wherein the first spring and the second spring each comprises a carbon fiber reinforced plastic material.
Example 21. The suspension assembly of any one of the preceding Examples, wherein the suspension assembly further comprises: a third one or more springs each having an outer end portion coupled to the frame, an inner end portion coupled to the collar, and an intermediate portion between the outer end portion and the inner end portion, the intermediate portion being displaced in the inward direction; a fourth one or more springs each having an outer end portion coupled to the frame, an inner end portion coupled to the collar, and an intermediate portion between the outer end portion and the inner end portion, the intermediate portion being displaced in the inward direction, wherein each of the third one or more springs is arranged opposite the collar from a corresponding one of the fourth one or more springs.
Example 22. The suspension assembly of any one of the preceding Examples, wherein the springs are evenly spaced apart from one another circumferentially around the collar.
Example 23. An audio transducer, comprising: a diaphragm; a voice coil configured to receive an electrical signal from an amplifier, and, in response to the received electrical signal, correspondingly move the diaphragm inward or outward along an axis; and a suspension assembly coupled to the voice coil, the suspension assembly comprising: an annular frame; a plurality of first springs each having a radially outer end portion coupled to the frame, a radially inner end portion operably coupled to the voice coil, and an intermediate portion between the outer end portion and the inner end portion, the intermediate portion being displaced in the inward direction from the outer end portion and the inner end portion; and a plurality of second springs each having a radially outer end portion coupled to the frame, a radially inner end portion operably coupled to the voice coil, and an intermediate portion between the outer end portion and the inner end portion, the intermediate portion being displaced in the outward direction from the outer end portion and the inner end portion.
Example 24. The audio transducer of any one of the preceding Examples, wherein each spring comprises an attachment feature configured to 1) couple the outer end portion of the spring to the frame and ii) engage an actuator that compresses the spring.
Example 25. The audio transducer of any one of the preceding Examples, wherein the first and second springs are in compression such that the suspension assembly provides a negative stiffness to movement of the diaphragm inward or outward along the axis.
Example 26. The audio transducer of any one of the preceding Examples, wherein the intermediate portions of the first springs and the intermediate portions of the second springs are each corrugated.
Example 27. The audio transducer of any one of the preceding Examples, wherein the first springs and the second springs each comprise a carbon fiber reinforced plastic material.
Example 28. The audio transducer of any one of the preceding Examples, wherein the first springs and second springs are spaced apart from one another circumferentially around the voice coil in an alternating fashion such that each first spring is separated from an adjacent first spring by one of the second springs.
Example 29. The audio transducer of any one of the preceding Examples, wherein the springs are evenly spaced apart from one another circumferentially around the voice coil.
Example 30. The audio transducer of any one of the preceding Examples, wherein the number of first springs and the number of second springs are equal.
Example 31. The audio transducer of any one of the preceding Examples, wherein the suspension assembly is arranged to provide a negative stiffness in response to corresponding movement of the diaphragm along the axis.
Example 32. The audio transducer of any one of the preceding Examples, wherein the suspension assembly comprises a collar surrounding and coupled to the voice coil, and wherein the inner end portion of the first spring and the inner end portion of the second spring are each affixed to the collar.
Example 33. The audio transducer of any one of the preceding Examples, further comprising a basket, wherein the annular frame is coupled to the basket.
Example 34. The audio transducer of any one of the preceding Examples, wherein the frame comprises a basket.
Example 35. A suspension assembly for an audio transducer, the suspension assembly comprising: an annular frame; a collar configured to be disposed around a voice coil; a plurality of first suspension members each having a first radially outer end portion coupled to the frame, a radially inner end portion coupled to the collar, and an intermediate portion between the outer end portion and the inner end portion, the intermediate portion being displaced in a first axial direction from the inner end portion and the outer end portion; and a plurality of second suspension members each having a radially outer end portion coupled to the frame, a radially inner end portion coupled to the collar, and an intermediate portion between the outer end portion and the inner end portion, the intermediate portion being displaced in a second axial direction opposite the first axial direction from the inner end portion and the outer end portion, wherein the assembly is configured such that each of the first and second suspension members are in compression when the annular frame lies in the same plane as the collar.
Example 36. The suspension assembly of any one of the preceding Examples, wherein each spring comprises an attachment feature configured to 1) couple the outer end portion of the spring to the frame and ii) engage an actuator that compresses the spring.
Example 37. The suspension assembly of any one of the preceding Examples, wherein the first and second suspension members comprise resilient members.
Example 38. The suspension assembly of any one of the preceding Examples, wherein the first and second suspension members comprise springs.
Example 39. The suspension assembly of any one of the preceding Examples, wherein the intermediate portions of the first suspension members and the second suspension members are each corrugated.
Example 40. The suspension assembly of any one of the preceding Examples, wherein the first suspension members and the second suspension members each comprise a carbon fiber reinforced plastic material.
Example 41. The suspension assembly of any one of the preceding Examples, wherein the first springs and second springs are spaced apart from one another circumferentially around the voice coil in an alternating fashion such that each first spring is separated from an adjacent first spring by one of the second springs.
Example 42. The suspension assembly of any one of the preceding Examples, wherein the suspension members are evenly spaced apart from one another circumferentially around the collar.
Example 43. The suspension assembly of any one of the preceding Examples, wherein the number of first suspension members and the number of second suspension members are equal.
Example 44. The suspension assembly of any one of the preceding Examples, wherein each suspension member comprises an attachment feature that couples the outer end portion of the suspension member to the frame.
Example 45. A method of assembling a suspension assembly for an audio transducer, the method comprising: providing a suspension assembly comprising a collar and a plurality of springs each having a radially inner end portion coupled to the collar and a radially outer end portion opposite the radially inner end portion, the outer end portion comprising an attachment feature; for each spring: coupling the attachment feature of the outer end portion to an annular frame; moving the attachment feature and the outer end portion along a radially inward direction with respect to the frame, thereby increasing compression of the spring; and securing the outer end portion with respect to the frame, thereby preventing movement along the radial direction with respect to the frame.
Example 46. The method of any one of the preceding Examples, further comprising securing the collar of the suspension assembly to a fixture.
Example 47. The method of any one of the preceding Examples, wherein the attachment features comprise receptacles, and wherein coupling the attachment feature of the outer end portion to the annular frame comprises placing the frame within the receptacle.
Example 48. The method of any one of the preceding Examples, wherein, after coupling the attachment feature of the outer end portion to the annular frame, and before securing the outer end portion with respect to the frame, the attachment feature can move along the radial direction over a limited range of motion.
Example 49. The method of any one of the preceding Examples, wherein moving the attachment feature and the outer end portion along the radially inward direction with respect to the frame comprises applying a linear actuator.
Example 50. The method of any one of the preceding Examples, wherein the springs comprise a plurality of first springs each having an intermediate portion between the outer end portion and the inner end portion, the intermediate portion being displaced in a first axial direction from the outer end portion and the inner end portion, and a plurality of second springs each having an intermediate portion between the outer end portion and the inner end portion, the intermediate portion being displaced in a second axial direction opposite the first axial direction from the outer end portion and the inner end portion.
Example 51. The method of any one of the preceding Examples, further comprising arranging the first springs and second springs to be spaced apart from one another circumferentially around the collar in an alternating fashion such that each first spring is separated from an adjacent first spring by one of the second springs.

1. An audio transducer, comprising:
a diaphragm;
a voice coil configured to receive an electrical signal from an amplifier, and, in response to the received electrical signal, correspondingly move the diaphragm inward or outward along an axis; and
a suspension assembly coupled to the voice coil, the suspension assembly comprising:
an annular frame;
a plurality of first springs each having a radially outer end portion coupled to the frame, a radially inner end portion operably coupled to the voice coil, and an intermediate portion between the outer end portion and the inner end portion, the intermediate portion being displaced in the inward direction from the outer end portion and the inner end portion; and
a plurality of second springs each having a radially outer end portion coupled to the frame, a radially inner end portion operably coupled to the voice coil, and an intermediate portion between the outer end portion and the inner end portion, the intermediate portion being displaced in the outward direction from the outer end portion and the inner end portion,
wherein each spring comprises an attachment feature configured to 1) couple the outer end portion of the spring to the frame and ii) engage an actuator that compresses the spring.

2. The audio transducer of claim 1, wherein the first and second springs are in compression such that the suspension assembly provides a negative stiffness to movement of the diaphragm inward or outward along the axis.

3. The audio transducer of claim 1, wherein the intermediate portions of the first springs and the intermediate portions of the second springs are each corrugated.

4. The audio transducer of claim 1, wherein the first springs and the second springs each comprise a carbon fiber reinforced plastic material.

5. The audio transducer of claim 1, wherein the first springs and second springs are spaced apart from one another circumferentially around the voice coil in an alternating fashion such that each first spring is separated from an adjacent first spring by one of the second springs.

6. (canceled)

7. (canceled)

8. The audio transducer of claim 1, wherein the suspension assembly is arranged to provide a negative stiffness in response to corresponding movement of the diaphragm along the axis.

9. The audio transducer of claim 1, wherein the suspension assembly comprises a collar surrounding and coupled to the voice coil, and wherein the inner end portion of the first spring and the inner end portion of the second spring are each affixed to the collar.

10. (canceled)

11. (canceled)

12. A suspension assembly for an audio transducer, the suspension assembly comprising:
an annular frame;
a collar configured to be disposed around a voice coil;
a plurality of first suspension members each having a first radially outer end portion coupled to the frame, a radially inner end portion coupled to the collar, and an intermediate portion between the outer end portion and the inner end portion, the intermediate portion being displaced in a first axial direction from the inner end portion and the outer end portion; and
a plurality of second suspension members each having a radially outer end portion coupled to the frame, a radially inner end portion coupled to the collar, and an intermediate portion between the outer end portion and the inner end portion, the intermediate portion being displaced in a second axial direction opposite the first axial direction from the inner end portion and the outer end portion,
wherein the assembly is configured such that each of the first and second suspension members are in compression when the annular frame lies in the same plane as the collar.

13. The suspension assembly of claim 12, wherein the first and second suspension members comprise resilient members.

14. The suspension assembly of claim 12, wherein the first and second suspension members comprise springs.

15. The suspension assembly of claim 12, wherein the intermediate portions of the first suspension members and the second suspension members are each corrugated.

16. The suspension assembly of claim 12, wherein the first suspension members and the second suspension members each comprise a carbon fiber reinforced plastic material.

17. The suspension assembly of claim 12, wherein the first suspension members and second suspension members are spaced apart from one another circumferentially around the voice coil in an alternating fashion such that each first suspension member is separated from an adjacent first suspension member by one of the second suspension members.

18. (canceled)

19. (canceled)

20. The suspension assembly of claim 12, wherein each suspension member comprises an attachment feature that couples the outer end portion of the suspension member to the frame.

21. A method of assembling a suspension assembly for an audio transducer, the method comprising:
providing a suspension assembly comprising a collar and a plurality of springs each having a radially inner end portion coupled to the collar and a radially outer end portion opposite the radially inner end portion, the outer end portion comprising an attachment feature;
for each spring:
coupling the attachment feature of the outer end portion to an annular frame;
moving the attachment feature and the outer end portion along a radially inward direction with respect to the frame, thereby increasing compression of the spring; and
securing the outer end portion with respect to the frame, thereby preventing movement along the radial direction with respect to the frame.

22. (canceled)

23. The method of claim 21, wherein the attachment features comprise receptacles, and wherein coupling the attachment feature of the outer end portion to the annular frame comprises placing the frame within the receptacle.

24. The method of claim 21, wherein, after coupling the attachment feature of the outer end portion to the annular frame, and before securing the outer end portion with respect to the frame, the attachment feature can move along the radial direction over a limited range of motion.

25. The method of claim 21, wherein moving the attachment feature and the outer end portion along the radially inward direction with respect to the frame comprises applying a linear actuator.

26. The method of claim 21, wherein the springs comprise a plurality of first springs each having an intermediate portion between the outer end portion and the inner end portion, the intermediate portion being displaced in a first axial direction from the outer end portion and the inner end portion, and a plurality of second springs each having an intermediate portion between the outer end portion and the inner end portion, the intermediate portion being displaced in a second axial direction opposite the first axial direction from the outer end portion and the inner end portion.

27. The method of claim 26, further comprising arranging the first springs and second springs to be spaced apart from one another circumferentially around the collar in an alternating fashion such that each first spring is separated from an adjacent first spring by one of the second springs.
